(19) United States
(12) Patent Application Publication
(10) Pub. No.: US 2018/0018712 A1
(43) Pub. Date: Jan. 18, 2018

(54) PROVIDER IDENTIFIER ANNOUNCEMENT INSERTION

(71) Applicant: iHeartCommunications, Inc., San Antonio, TX (US)

(72) Inventors: Marcel Henry Walden, Brooklyn, NY (US); Ryan R. Sult, Fairfield, CT (US)

(21) Appl. No.: 15/210,137

(22) Filed: Jul. 14, 2016

(51) Int. Cl. G06Q 30/02; H04L 29/06; H04L 29/08

(52) U.S. Cl. CPC G06Q 30/0277; H04L 67/18; H04L 65/4069; H04L 65/602

(57) ABSTRACT

A system includes a playlist manager configured to generate a media stream at a device associated with a provider. The media stream includes multiple content items. The playlist manager is also configured to assign a priority ranking to each of a plurality of provider identifier announcements based on one or more selection criteria. Each of the plurality of provider identifier announcements identifies the provider. The playlist manager is further configured to insert a provider identifier announcement of the plurality of provider identifier announcements in the media stream based on the priority ranking and one or more campaign criteria of a campaign associated with the provider identifier announcement. The one or more campaign criteria include at least one of a campaign start time, a campaign end time, or a frequency of inserting the provider identifier announcement in the media stream. Other aspects are also disclosed.

### I. FIELD

The present disclosure relates to systems and methods of inserting provider identifier announcements in a media stream.

### II. BACKGROUND

On-line streaming of media, by a media provider, may enable media content (e.g., audio content) to be provided to one or more client devices (e.g., mobile devices). A user may receive a media stream corresponding to an internet radio station from the media provider. For example, the user may select, at a client device, a station corresponding to an artist, an activity (e.g., Working Out), a genre (e.g., Classic Rock), a demographic (e.g., Kids), etc. The media provider may provide a media stream including content items (e.g., music tracks) associated with the selected station to the client device.

The client device may be operable to receive media streams from multiple media providers. A media provider may insert a provider identifier announcement that identifies the media provider in the media stream. For example, a user may, at a first time, enjoy listening to a first media stream received from the media provider. The first media stream may include a provider identifier announcement identifying the media provider. The user may associate a positive media streaming experience with the media provider. The user may, at a second time, choose to listen to another media stream from the same media provider because of the positive association with the media provider.

### III. SUMMARY

Systems and methods of inserting a provider identifier announcement in a media stream are disclosed. Selection of the provider identifier announcement based on various characteristics may result in a more enjoyable user experience, which in some situations may lead to a positive association with the media provider.

In a particular aspect, a system includes a playlist manager configured to generate a media stream at a device associated with a media provider. The media stream includes multiple content items. The playlist manager is configured to assign a priority ranking to each of a plurality of provider identifier announcements based on one or more selection criteria. Each of the plurality of provider identifier announcements identifies the media provider (e.g., “This song is brought to you by Internet Radio USA”). A first provider identifier announcement may include a voice of a first artist, a second provider identifier announcement may include music performed by a second artist, a third provider identifier announcement may include a voice of a character (e.g., a cartoon character) for kids, and so on. The playlist manager is further configured to insert a provider identifier announcement of the plurality of provider identifier announcements in the media stream based on the priority ranking and based on one or more campaign criteria of a campaign associated with the provider identifier announcement. The campaign may be associated with a time range (e.g., a date range) during which the provider identifier announcement is available to be added to one or more media streams. The one or more campaign criteria include at least one of a campaign start time, a campaign end time, or a frequency of inserting the provider identifier announcement in the media stream.

In another particular aspect, a method includes generating a media stream at a device (e.g., a computer server of a media provider). The media stream includes multiple content items. The method also includes assigning, at the device, a priority ranking to each of a plurality of provider identifier announcements based on one or more selection criteria. The method further includes inserting, at the device, a provider identifier announcement of the plurality of provider identifier announcements in the media stream based on the priority ranking and based on one or more campaign criteria of a campaign associated with the provider identifier announcement. The one or more campaign criteria include at least one of a campaign start time, a campaign end time, or a frequency of inserting the provider identifier announcement in the media stream.

In another particular aspect, a computer-readable storage device stores instructions that, when executed by a processor, cause the processor to perform operations including generating a media stream at a device associated with a media provider. The media stream includes multiple content items. The operations also include assigning a priority ranking to each of a plurality of provider identifier announcements based on one or more selection criteria. Each of the plurality of provider identifier announcements identifies the media provider. The operations further include inserting a provider identifier announcement of the plurality of provider identifier announcements in the media stream based on the priority ranking and based on one or more campaign criteria of a campaign associated with the provider identifier announcement. The one or more campaign criteria include at least one of a campaign start time, a campaign end time, or a frequency of inserting the provider identifier announcement in the media stream.

Aspects, advantages, and features of the present disclosure will become apparent after review of the entire application, including the following sections: Brief Description, Detailed Description, and the Claims.

### IV. BRIEF DESCRIPTION

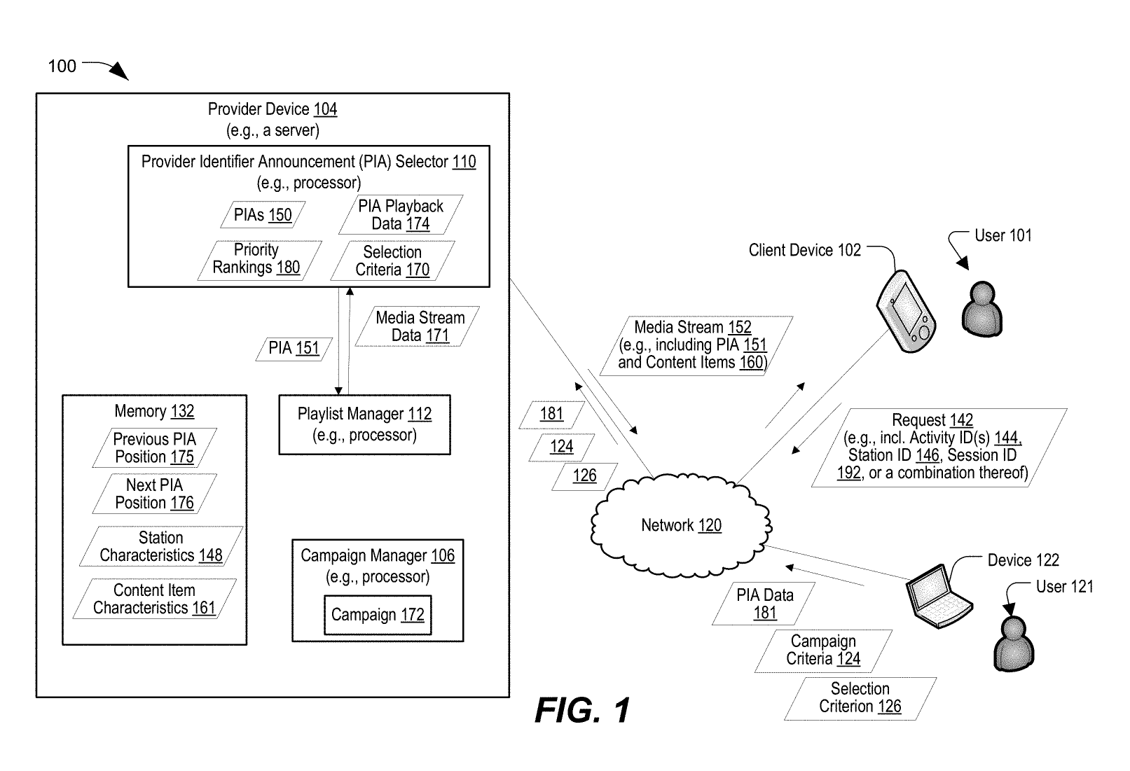

FIG. 1 is a block diagram of a particular illustrative aspect of a system that includes a device that is operable to insert provider identifier announcements into a media stream;

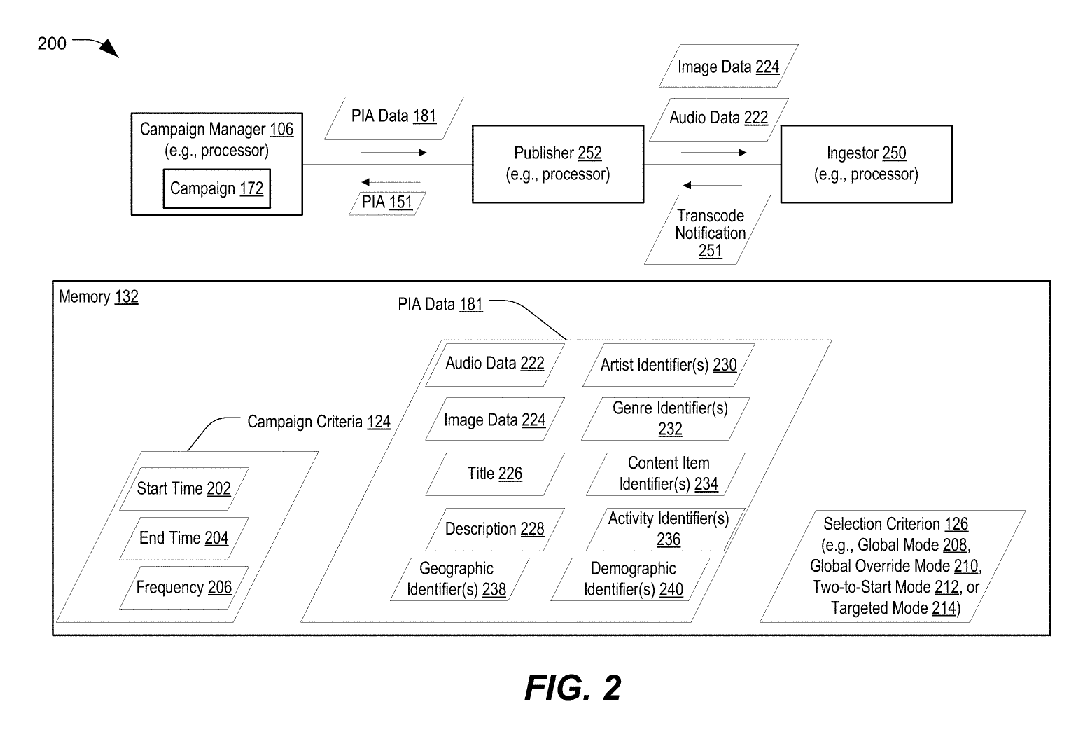

FIG. 2 is a diagram of a particular illustrative aspect of a system that includes one or more components of the device of FIG. 1;

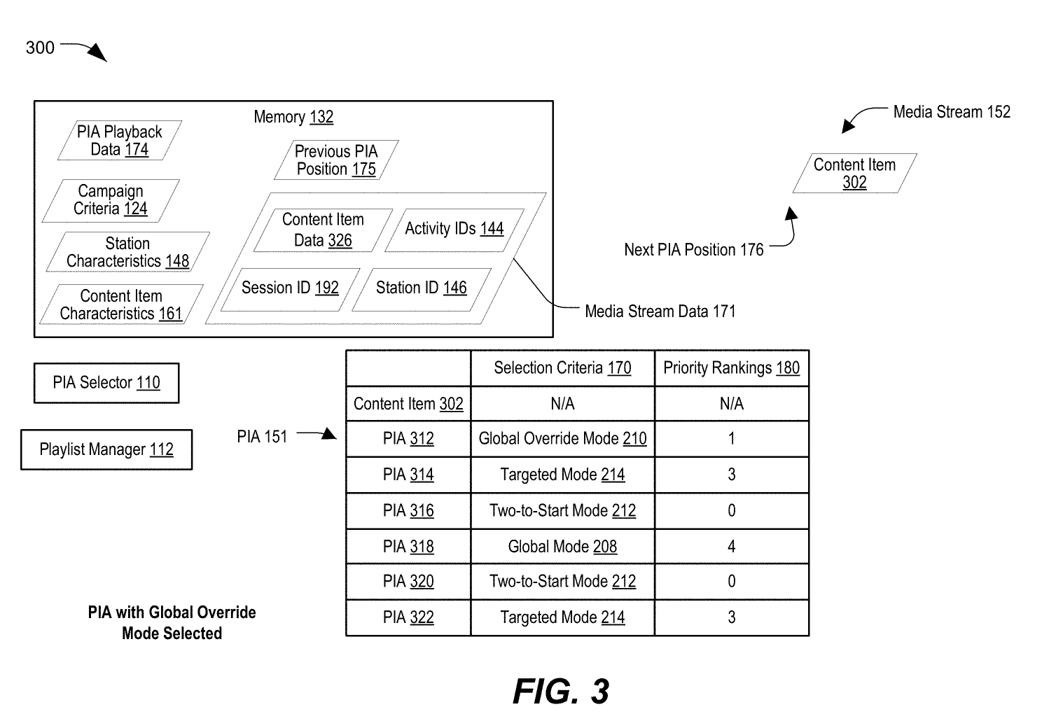

FIG. 3 is a diagram of a particular illustrative aspect of a system that includes one or more components of the device of FIG. 1;

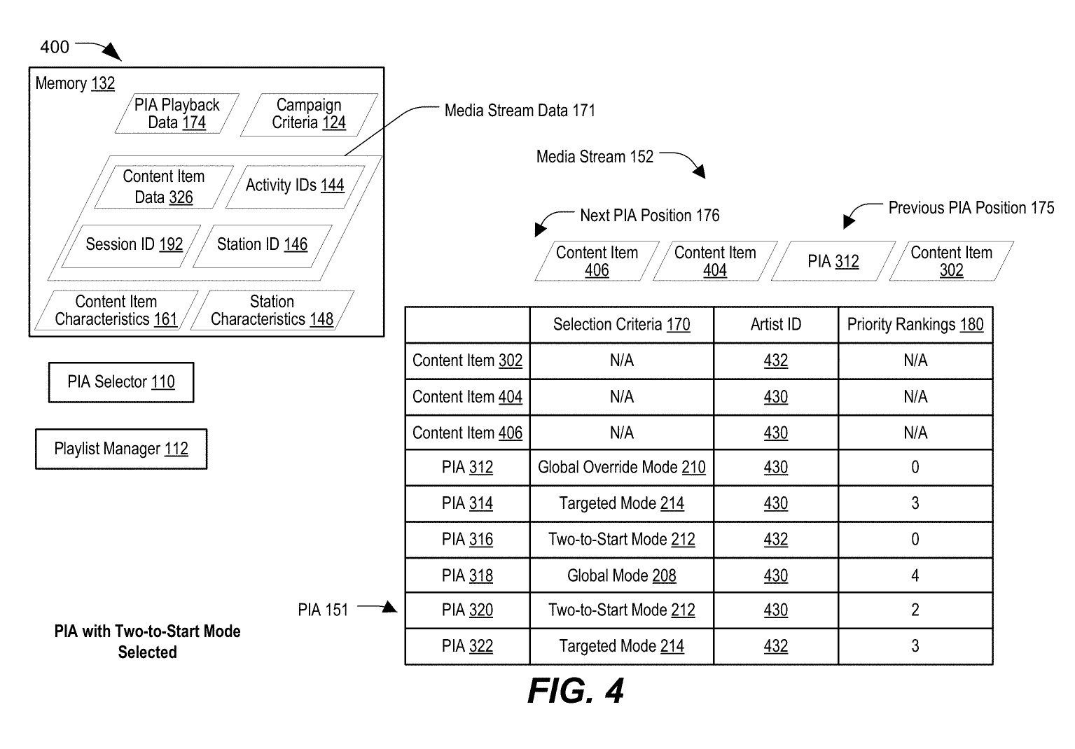

FIG. 4 is a diagram of a particular illustrative aspect of a system that includes one or more components of the device of FIG. 1;

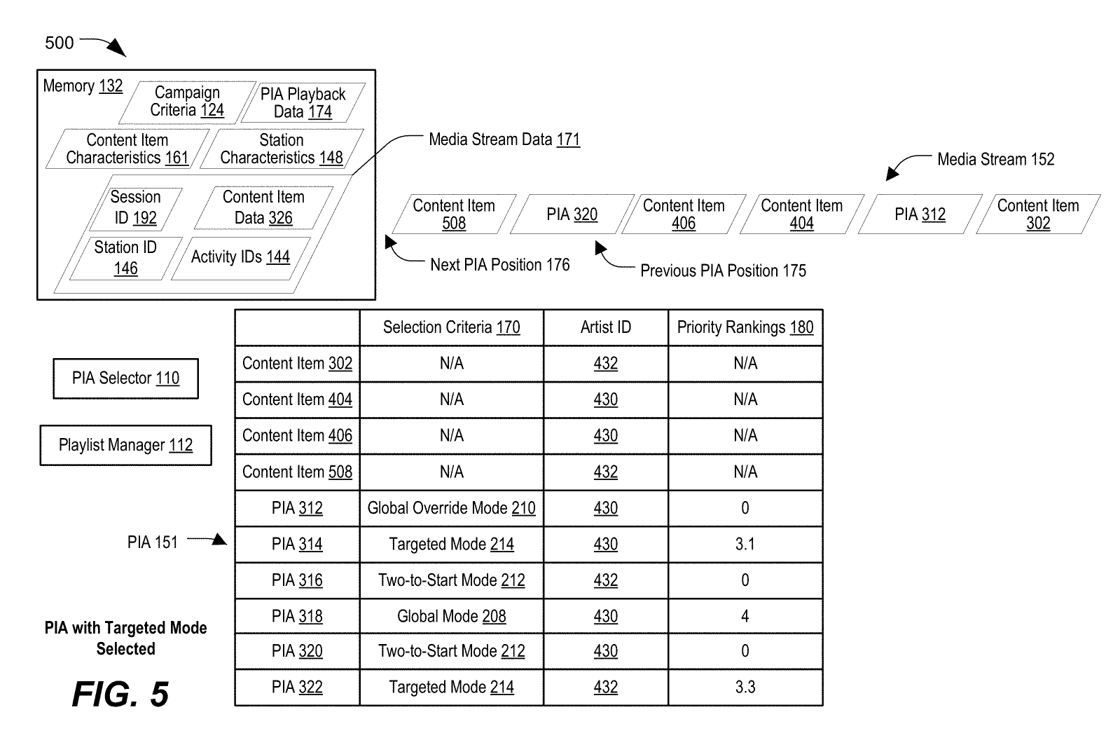

FIG. 5 is a diagram of a particular illustrative aspect of a system that includes one or more components of the device of FIG. 1;

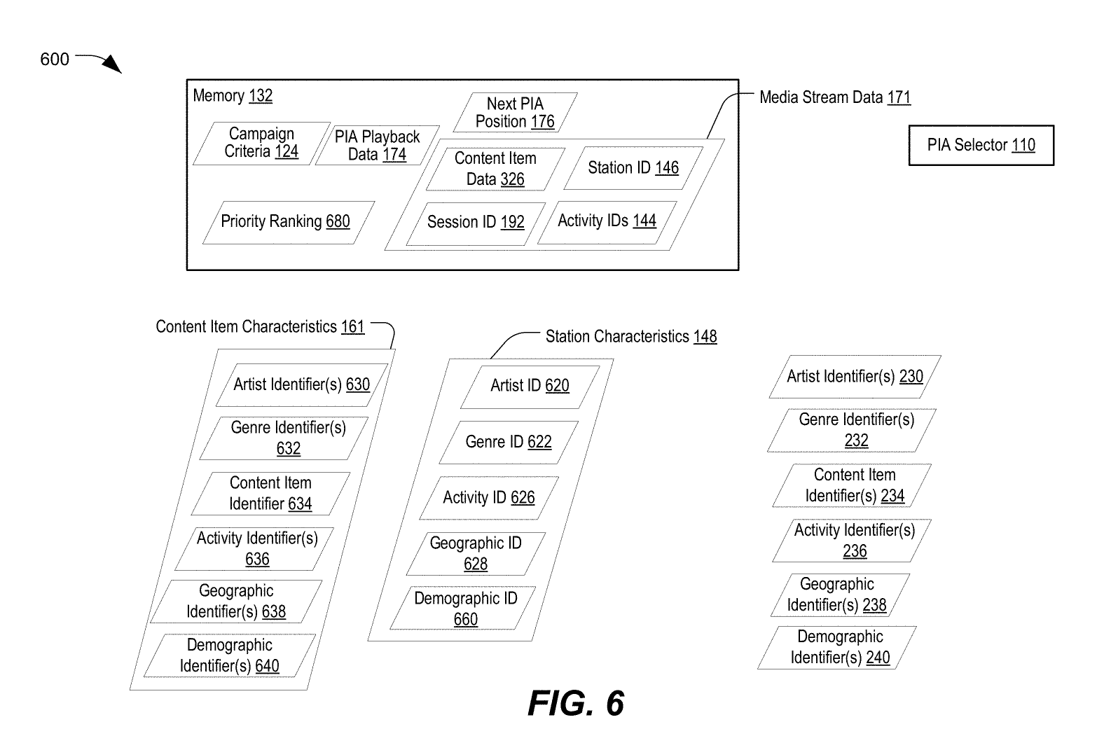

FIG. 6 is a diagram of a particular illustrative aspect of a system that includes one or more components of the device of FIG. 1;

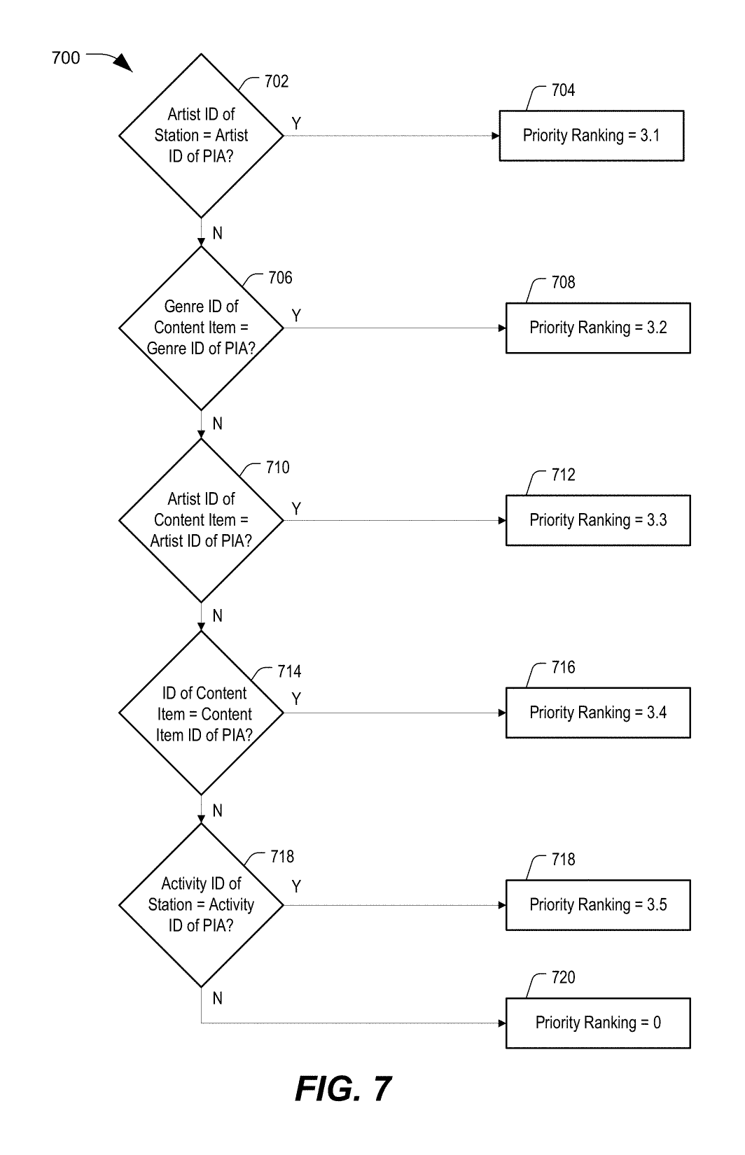

FIG. 7 is a flow chart to illustrate a method of inserting a provider identifier announcement into a media stream;

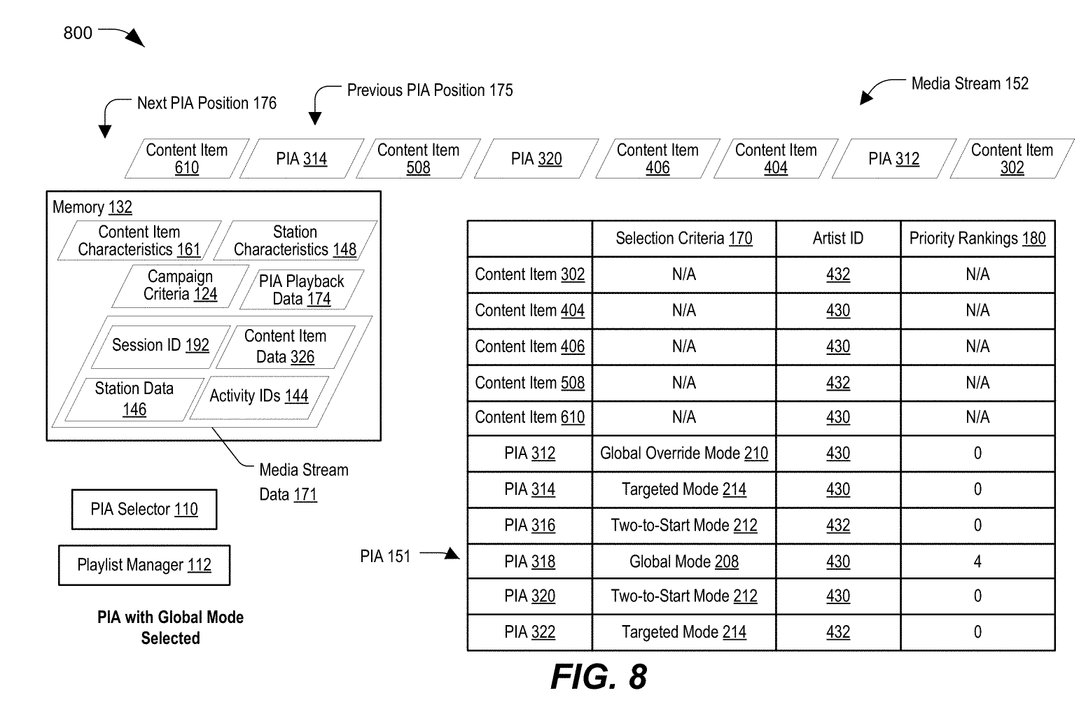

FIG. 8 is a diagram of a particular illustrative aspect of a system that includes one or more components of the device of FIG. 1;

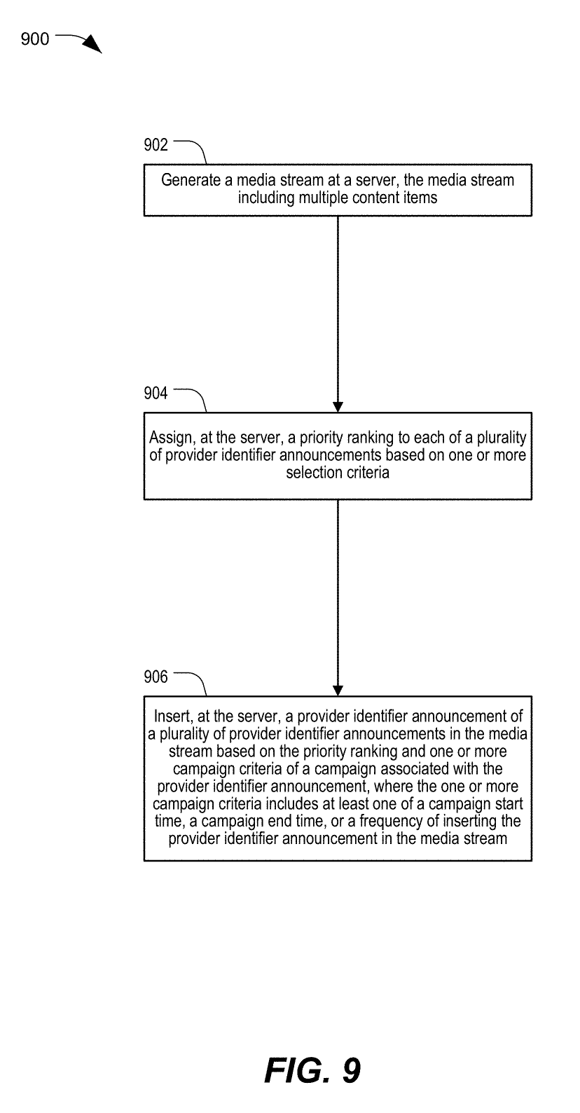

FIG. 9 is a flow chart to illustrate an aspect of a method of inserting a provider identifier announcement into a media stream; and

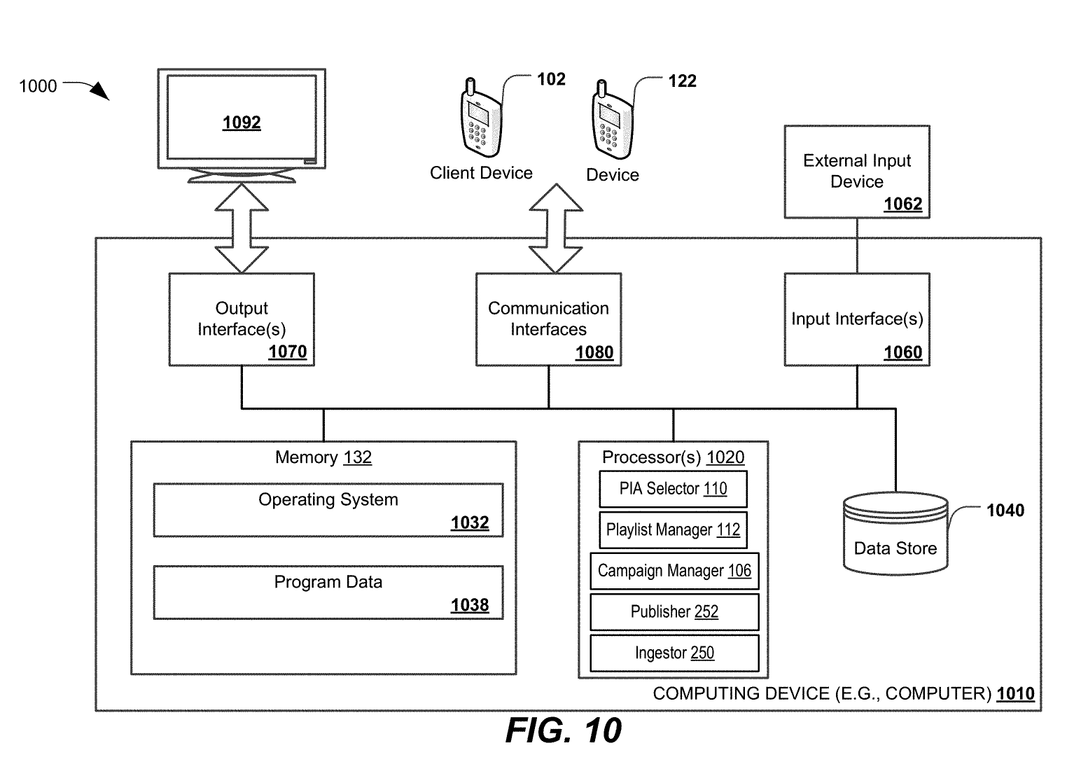

FIG. 10 is a block diagram of a device operable to perform provider identifier announcement insertion in accordance with the systems, devices, and methods of FIGS. 1-9.

### V. DETAILED DESCRIPTION

The terminology used herein is for the purpose of describing particular aspects only and is not intended to be limiting of the claims. As used herein, the singular forms “a,” “an,” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When a media content provider offers multiple media streams, such as internet radio stations or internet broadcasts of local/regional/national radio stations, a user may use a website or mobile application to select one or more of the offered media streams. For example, the user may select an internet radio station by selecting a corresponding option via a user interface displayed by a client device. The client device may, in response to receiving the selection of the option, send a request indicating the selected station to the provider device. The provider device may access (or generate) the media stream in response to receiving the request. For example, the provider device may access the media stream corresponding to the selected station. As another example, the provider device may dynamically generate the media stream. To illustrate, the provider device may, in response to receiving user feedback regarding a content item of the media stream, select a subsequent content item of the media stream based on the user feedback, the selected station, or both.

While listening to an internet radio station, the user may occasionally hear a provider identifier announcement (PIA), such as “You're listening to classical music radio station, brought to you by Internet Radio USA.” A provider may have access to multiple such PIAs, which may be alternatively referred to as “sweepers,” for inclusion in media streams. A PIA may include an audio identifier of the provider, a visual identifier of the provider (e.g., for display on the user interface at the client device), or both. For example, the PIA may include a voice recording identifying the provider (e.g., “You're listening to Internet Radio USA”), a sound (e.g., a jingle) identifying or associated with the provider, text identifying the provider (e.g., a name of the provider), an image of a logo identifying the provider, or a combination thereof. The PIA may be associated with one or more characteristics, such as an activity, a genre (e.g., a format), a demographic, or a geographic location. For example, a PIA included in a media stream associated with a specific artist may include a voice recording of the artist. As another example, a PIA included in a media stream associated with a particular type of activity (e.g., dancing) may include a corresponding type of music (e.g., upbeat dance music). As another example, a PIA included in a media stream associated with a particular genre of music may include that type of music (e.g., a PIA in a pop radio station may include pop music). As yet another example, a PIA in a children's station may be recorded in a cartoon character's voice. As yet another example, a PIA presented to a user in a specific geographic region (e.g., Texas) may include music (e.g., country music) that is popular in the geographic region.

Thus, a provider device (e.g., a computer server) may have a plurality of PIAs that are available for inclusion in one or more media streams. The provider device may select one of the PIAs for inclusion in a particular media stream to be delivered to a particular user during a particular session at a particular time. The provider device may determine selection criteria associated with the plurality of PIAs. For example, a PIA may be associated with a selection criterion (e.g., a global override mode, a two-to-start mode, a targeted mode, or a global mode). To illustrate, a second user (e.g., an employee of the provider) may provide the selection criterion via a user interface to the provider device. The selection criterion may indicate conditions when the PIA is to be included in the media stream. For example, the global override mode may indicate that the PIA is to be included once in the media stream. The two-to-start mode may indicate that the PIA is to be included in the media in response to determining that the media stream includes at least two consecutive content items associated with the same artist as the PIA. The targeted mode may indicate that the PIA is to be included in the media stream in response to determining that the PIA has at least one characteristic (e.g., an activity, a genre, a demographic, or a geographic location) in common with the station or with a content item of the media. The global mode may indicate that the PIA is to be included in the media stream in response to determining that no PIA corresponding to another mode (e.g., the global override mode, a two-to-start mode, or a targeted mode) is available.

The provider device may prioritize the plurality of PIAs based on their respective selection criteria. For example, the provider device may determine that a particular PIA has a first priority ranking in response to determining that the selection criterion associated with the PIA indicates the global override mode and that the PIA has not been included in a particular media stream being delivered to a particular user during a particular session or in any media stream delivered to the particular user during the particular session. The provider device may determine that the PIA has a second priority ranking in response to determining that the selection criterion indicates the two-to-start mode and that the media stream includes at least two consecutive content items that are associated with the same artist as the PIA. The provider device may determine that the PIA has a third priority ranking in response to determining that the selection criterion indicates the targeted mode and the PIA has at least one characteristic in common with the station or at least one content item of the media stream. The provider device may determine that the PIA has a fourth priority ranking in response to determining that the selection criterion indicates the global mode.

The provider device may select a PIA for inclusion in a media stream based on a priority ranking and a PIA campaign associated with the PIA. Campaign criteria of the PIA campaign may indicate a date range during which the PIA is available for inclusion in a media stream. For example, the provider device may determine that a subset of the plurality of PIAs satisfy corresponding campaign criteria. The provider device may select a PIA of the subset in response to determining that the PIA has a highest priority amongst the PIAs of the subset. The provider device may provide the media stream (including the PIA) to the client device. During playback of the media stream at the client device, the PIA may be played between content items as a reminder (e.g., “You're listening to Internet Radio USA”) of the provider. Alternatively, or in addition, the client device may provide a visual identifier of the provider to a display in response to determining that the PIA includes the visual identifier. The PIA, selected based at least in part on the priority ranking, may more closely correspond to the tastes and preferences of the user. The user may be more receptive to the PIA because the PIA is targeted to the tastes and preferences of the user. The user may be less likely to perceive the PIA as an unwelcome interruption when the PIA conforms (e.g., corresponds to the same artist, same demographic, etc.) to one or more content items of the media stream, resulting in an improved user experience.

Referring to FIG. 1, a particular illustrative aspect of a system is disclosed and generally designated 100. The system 100 includes a provider device 104 (e.g., a computer server). The provider device 104 may be coupled, via a network 120, to one or more devices. For example, the provider device 104 may be coupled, via the network 120, to a device 122, a client device 102, or both. The network 120 may include a wired network, a wireless network, or both. The provider device 104 is configured to select a PIA 151 from a plurality of PIAs 150 based on one or more selection criteria 170, one or more campaign criteria 124, or a combination thereof.

Each of the PIAs 150 may include an audio identifier of the provider device 104, a visual identifier of the provider device 104, or both. For example, the PIA 151 may include a voice recording including an identifier of the provider device 104 (e.g., “You're listening to Internet Radio USA”), a sound (e.g., a jingle) including an identifier of the provider device, text including an identifier of the provider device 104 (e.g., a name of the provider), a logo including an identifier of the provider device 104, or a combination thereof. As referred to herein, an “identifier of the provider device 104” may include a media service identifier of a media streaming service provided by the provider device 104, an identifier of a company that has a right to access (e.g., owns, rents, or leases) the provider device 104, or another identifier associated with the provider device 104.

The provider device 104 may include a memory 132, a campaign manager 106, a playlist manager 112, a PIA selector 110, or a combination thereof. The memory 132 may be configured to store data. For example, the memory 132 may store station characteristics 148 associated with a station. To illustrate, the station characteristics 148 may indicate that a station corresponding to a station identifier (ID) 146 is associated with one or more artists, one or more genres, one or more geographic locations, one or more demographics, one or more activities, or a combination thereof. An artist associated with a station may be referred to as a “station artist.” A genre associated with a station may be referred to as a “station genre.” A geographic location associated with a station may be referred to as a “station geographic location.” A demographic associated with a station may be referred to as a “station demographic.” An activity associated with a station may be referred to as a “station activity.” The memory 132 may also store content item characteristics 161 associated with a plurality of content items (e.g., songs). To illustrate, the content item characteristics 161 may indicate that a content item having a particular content item identifier (ID) is associated with one or more artists, one or more genres, one or more geographic locations, one or more demographics, one or more activities, or a combination thereof. An artist associated with a content item may be referred to as a “content item artist.” A genre associated with a content item may be referred to as a “content item genre.” A geographic location associated with a content item may be referred to as a “content item geographic location.” A demographic associated with a content item may be referred to as a “content item demographic.” An activity associated with a content item may be referred to as a “content item activity.”

The campaign manager 106 may be configured to generate, based on the campaign criteria 124, a campaign 172 associated with the PIA 151. The PIA selector 110 may be configured to select the PIA 151 from the plurality of PIAs 150 based on the selection criteria 170, the campaign criteria 124, or a combination thereof, as described herein, and to provide the PIA 151 to the playlist manager 112. The playlist manager 112 may be configured to generate the media stream 152, to insert the PIA 151 in the media stream 152, and to provide the media stream 152 (with the PIA 151), via the network 120, to the client device 102. For example, the playlist manager 112 may provide the PIA 151 (or a particular content item of the content items 160) by providing audio data, image data, or both, associated with the PIA 151 (or the particular content item), by providing an address (e.g., a universal resource locator (URL)) of the PIA 151 (or the particular content item), or a combination thereof. In a particular aspect, the playlist manager 112 may provide each of the content items 160 and the PIA 151 at substantially the same time. For example, the playlist manager 112 may provide a list of addresses (e.g., URLs) of the content items 160 and the PIA 151. In an alternate aspect, the playlist manager 112 may provide a first subset of the media stream 152 at a first time and a second subset of the media stream 152 at a second time that is subsequent to the first time. For example, the playlist manager 112 may provide one address at a time of the addresses corresponding to the content items 160 and the PIA 151. To illustrate, the playlist manager 112 may provide a first content item of the content items 160 (e.g., a first content item address) at a first time to the client device 102. The PIA selector 110 may select the PIA 151 while the first content item is played at the client device 102. The playlist manager 112 may provide the PIA 151 (e.g., an address of the PIA 151) at a second time to the client device 102. The second time may be subsequent to the first time. The second time may be less than or equal to a time at which playback of the first content item ends at the client device 102. The client device 102 may play the PIA 151 subsequent to playing the first content item.

During a PIA generation phase, a user 121 (e.g., an employee of a provider) may use the device 122 to provide PIA data 181, a selection criterion 126, the campaign criteria 124, or a combination thereof, to the provider device 104 to generate the PIA 151. For example, the user 121 may provide the PIA data 181, the selection criterion 126, the campaign criteria 124, or a combination thereof, via one or more user interfaces displayed by the device 122. To illustrate, the user 121 may select (or upload) an audio file, an image file, or both, to include in the PIA data 181. The audio file may include an audio identifier of the provider device 104 (e.g., a voice recording of “You're listening to Internet Radio USA” with background music). The image file may include an image identifier of the provider device 104 (e.g., a logo of “Internet Radio USA”). The user 121 may select the campaign criteria 124 including a date range when the PIA 151 is available to be included in one or more media streams, a frequency of insertion of the PIA 151 in a media stream, or both. The user 121 may select the selection criterion 126 (e.g., a global override mode, a two-to-start mode, a targeted mode, or a global mode) associated with the PIA 151.

The campaign manager 106 may generate the PIA 151 based on the PIA data 181, as further described with reference to FIG. 2. For example, the PIA 151 may include audio data based on the audio file, image data based on the image file, or both. In a particular aspect, the audio data may be a transcoded version of the audio file, the image data may be a transcoded version of the image file, or both.

The campaign manager 106 may add the selection criterion 126 to the selection criteria 170 and may generate a campaign 172 associated with the PIA 151 based on the campaign criteria 124 (e.g., a campaign start time, a campaign end time, or both), as further described with reference to FIG. 2. The campaign 172 may be associated with a time range during which the PIA 151 is available to be inserted in one or more media streams.

During a media stream generation phase, a user 101 may use the client device 102 to send a request 142 via the network 120 to the provider device 104. For example, the client device 102 may display a user interface including options corresponding to multiple stations. A first station (e.g., a “Benjamin Chau” station) may be associated with an artist (e.g., “Benjamin Chau”), a second station (e.g., a “Top 40” station) may be associated with a genre (e.g., “Top 40”), and so on. The user 101 may select an option corresponding to the station associated with the station ID 146. The client device 102 may, in response to receiving a selection, send the request 142 to the provider device 104. The request 142 may include the station ID 146, a session ID 192 of a media streaming session, or both.

In a particular aspect, the client device 102 may send activity data (e.g., one or more activity IDs 144) to the provider device 104. The activity IDs 144 may be included in the request 142 or may be sent independently of the request 142. The activity IDs 144 may indicate one or more activities associated with the client device 102. For example, the client device 102 may detect the one or more activities based on a calendar stored at the client device 102, image data from an image sensor, audio data from an audio sensor, motion data from a motion sensor, data received from another component of the client device 102, data received from devices proximate to the client device 102, or a combination thereof. To illustrate, the client device 102 may receive an input from cooking equipment (e.g., a stovetop) indicating that the user 101 is cooking. As another example, the client device 102 may receive an input from an exercise monitoring device indicating that the user 101 is running. As another example, the client device 102 may determine that the user 101 is driving to the beach based on data generated by a mapping application.

The client device 102 may send the activity IDs 144 to the provider device 104 in conjunction with the request 142 or subsequent to sending the request 142. In a particular aspect, the client device 102 may provide the activity IDs 144 to a display and may send the activity IDs 144 in response to receiving a user input indicating approval to send the activity IDs 144 to the provider device 104.

The playlist manager 142 may receive the request 142, the activity data (e.g., the activity IDs 144), or both, from the client device 102. The playlist manager 112 may, in response to receiving the request 142, determine the content items 160 to include the media stream 152. The media stream 152 may be associated with the selected station, one or more of the activities associated with the client device 102, or a combination thereof.

The playlist manager 112 may determine a next PIA position 176 in the media stream 152 at which to include a PIA based on a previous PIA position 175 at which a PIA has been included in the media stream 152. The playlist manager 112 may initialize the previous PIA position 175 to a particular value (e.g., 0) in response to receiving the request 142. The playlist manager 112 may determine the next PIA position 176 (e.g., position 2) in the media stream 152 based on a previous PIA position 175 (e.g., position 0) and a threshold gap between PIAs (e.g., next PIA position 176≧previous PIA position 175+threshold gap+1), as further described with reference to FIGS. 4, 5, and 8. The next PIA position 176 may be subsequent to positions of one or more of the content items 160 in the media stream 152.

The playlist manager 112 may generate media stream data 171. The media stream data 171 may indicate the station ID 146, the activity IDs 144, the content items 160, the positions of the content items 160 in the media stream 152, the next PIA position 176, the previous PIA position 175, or a combination thereof. The playlist manager 112 may provide the media stream data 171 to the PIA selector 110.

The PIA selector 110 may select the PIA 151 based on various combinations of session data, stream data, user data, campaign data, and/or selection criteria, as described herein. The PIA selector 110 may provide the PIA 151 to the playlist manager 112 at a first time. The PIA selector 110 may update the PIA playback data 174 to indicate that the PIA 151 has been provided to the playlist manager 112 (or to the client device 102) at approximately the first time. The PIA selector 110 may update the PIA playback data 174 to indicate that the PIA 151 has been included at the next PIA position 176 in the media stream 152 associated with the session ID 192. The playlist manager 112 may provide the content items 160 and the PIA 151 of the media stream 152 to the client device 102. The playlist manager 112 may update the previous PIA position 175 to indicate the value of the next PIA position 176. The previous PIA position 175 may indicate a position in the media stream 152 of a most recently added PIA. The playlist manager 112 may update the next PIA position 176 based on the previous PIA position 175 and the threshold gap (e.g., a minimum gap) between PIAs (e.g., next PIA position 176≧previous PIA position 175+threshold gap+1). Determining the next PIA position 176 based on the previous PIA position 175 and the threshold gap may prevent PIAs from being too close to each other (e.g., one after the other) in the media stream 152. For example, the previous PIA position 175 may indicate that the media stream 152 includes a PIA at a first PIA position (e.g., 3). The playlist manager 112 may determine that a next PIA is to be included at or subsequent to a second position in the media stream 152. The second position (e.g., 9=3+5+1) may be based on the first PIA position (e.g., 3) and the threshold gap (e.g., 5) between PIAs. The threshold gap may thus indicate a minimum number of content items between successive PIAs. The next PIA position 176 may be greater than or equal to the second position. In a particular aspect, the media stream 152 may include more than the minimum number of content items between the first PIA and the next PIA.

The playlist manager 112 may iteratively stream additional content items and additional PIAs to the client device 102. For example, the playlist manager 112 may select one or more additional content items to add to the content items 160 based on the station ID 146, the activity IDs 144, or both. The additional content item(s) may be added at positions that are between the previous PIA position 175 and the next PIA position 176. The playlist manager 112 may update the media stream data 171. The media stream data 171 may indicate the content items 160 (including the additional content items), the positions of the content items 160 (including the additional content items) in the media stream 152, the next PIA position 176, the previous PIA position 175, or a combination thereof. The playlist manager 112 may provide the media stream data 171 to the PIA selector 110. The PIA selector 110 may select an additional PIA based at least in part on the media stream data 171 using the techniques described above. The playlist manager 112 may provide the additional content items and the additional PIA of the media stream 152 to the client device 102.

Various combinations of session data, stream data, user data, campaign data, and/or selection criteria may be used to determine which PIA should be inserted in a media stream. Some illustrative non-limiting examples of PIA selection are described below.

The PIA selector 110 may determine priority rankings 180 of the PIAs 150 based on the selection criteria 170, the PIA playback data 174, the media stream data 171, or a combination thereof. For example, the PIA selector 110 may determine that the PIA 151 has a first priority ranking, a second priority ranking, a third priority ranking, or a fourth priority ranking based at least in part on determining that the selection criterion 126 indicates the global override mode, the two-to-start mode, the targeted mode, or the global mode, respectively, as further described with reference to FIGS. 3-8. To illustrate, the PIA selector 110 may determine that the PIA 151 has the first priority ranking in response to determining that the selection criterion 126 indicates the global override mode, that the media stream data 171 indicates the session ID 192, and that the PIA playback data 174 indicates that the PIA 151 is not included in any media stream (e.g., the media stream 152, another media stream, or both) associated with a session corresponding to the session ID 192. A technical effect of determining a priority ranking of the PIA 151 based on the global override mode may be to enable the PIA selector 110 to override the tastes and preferences of the user 101 in certain situations. In this example, the PIA 151 will be included in media streams independently of tastes and preferences of users enjoying the media streams.

As another example, the PIA selector 110 may determine that the PIA 151 has the second priority ranking in response to determining that the selection criterion 126 indicates the two-to-start mode, that the PIA 151 is associated with an artist, and that a threshold number of preceding content items are associated with the same artist. To illustrate, the PIA selector 110 may determine that the threshold number of preceding content items include a first content item and a second content item in response to determining that the threshold number is 2, that a first position and a second position precede the next PIA position 176, that the media stream data 171 indicates that the first content item is at the first position in the media stream 152, and that the second content item is at the second position in the media stream 152. The PIA selector 110 may determine that the content item characteristics 161 indicate that the first content item and the second content item are associated with the artist. In a particular aspect, the PIA selector 110 may determine that the PIA 151 has the second priority ranking in response to determining that the PIA 151 is associated with an artist and that a count of consecutive content items of the media stream 152 that are associated with the artist satisfies (e.g., is greater than or equal to) a threshold. For example, the media stream 152 may include a first content item at a first position and a second content item at a second position. In a particular aspect, the media stream 152 may include one or more PIAs between the first position and the second position. In a particular aspect, the media stream 152 may include one or more PIAs between the second position and the next PIA position 176. In a particular aspect, the media stream 152 may include one or more content items between the second position and the next PIA position 176.

As another example, the PIA selector 110 may determine that the PIA 151 has the third priority ranking in response to determining that the selection criterion 126 indicates the targeted mode, that the media stream data 171 indicates that the media stream 152 is associated with a station, and that the PIA 151 has at least one of a station characteristic of the station characteristics 148 or a content item characteristic of the content item characteristics 161. In a particular aspect, the PIA selector 110 may determine that the PIA 151 has the third priority ranking in response to determining that the selection criterion 126 indicates the targeted mode and that the PIA 151 is associated with at least one of the activities indicated by the activity IDs 144. A technical effect of determining a priority ranking of the PIA 151 based on the common characteristics may be that the PIA 151 may more closely correspond to tastes and preferences of the user 101. The user 101 may be less likely to view the PIA 151 as an unwelcome interruption when the PIA 151 has common characteristics with a user selected station, with content items that the user 101 is listening to, or both.

In a particular aspect, the PIA selector 110 may determine the third priority ranking based on the common characteristic, as further described with reference to FIGS. 5-7. For example, the PIA selector 110 may determine that the PIA 151 has a first particular priority ranking in response to determining that the PIA 151 is associated with the same artist as the station, that the PIA 151 has a second particular priority ranking in response to determining that the PIA 151 is associated with the same genre as one or more of the content items 160, and so on. The PIA selector 110 may determine that the PIA 151 has the fourth priority ranking in response to determining that the selection criterion 126 indicates the global mode. A technical effect of determining a priority ranking of the PIA 151 based on the global mode may be to enable the PIA selector 110 to include the PIA 151 in the media stream 152 when no available PIAs are detected as corresponding to the tastes and preferences of the user 101.

In a particular aspect, the PIA selector 110 may determine (or update) the priority ranking of the PIA 151 based on a position at which the PIA 151 has been previously included in the media stream 152. For example, the PIA selector 110 may determine that the PIA playback data 174 indicates that the PIA 151 has been included in the media stream 152 at a first position. The PIA selector 110 may determine that the PIA 151 has a non-inclusion priority ranking (e.g., 0) in response to determining that a difference between the first position and the next PIA position 176 fails to satisfy (e.g., is less than) a threshold difference. The non-inclusion priority ranking (e.g., 0) may indicate that the PIA is not to be included in the media stream 152 at the next PIA position 176. A technical effect of determining whether to include the PIA 151 in the media stream 152 at the next PIA position 176 based on the first position may be to prevent close (e.g., successive) repetition of the PIA 151. Increasing a time between repetitions of the same PIA may improve a user experience.

In a particular aspect, the PIA selector 110 may determine (or update) the priority ranking of the PIA 151 based on a number of times that the PIA 151 has been included in the media stream 152 (or in any media stream associated with the session ID 192). For example, the PIA selector 110 may determine that the PIA playback data 174 indicates that the PIA 151 has been included in the media stream 152 (or in any media stream associated with the session ID 192) a first number of times. The PIA selector 110 may determine that the PIA 151 has the non-inclusion priority ranking (e.g., 0) in response to determining that the first number of times fails to satisfy (e.g., is greater than or equal to) a threshold (e.g., a maximum) number of times. A technical effect of determining whether to include the PIA 151 in the media stream 152 at the next PIA position 176 based on a number of times that the PIA 151 has been included in the media stream 152 (or in any media stream associated with the session ID 192) may be to prevent too many (e.g., greater than the threshold number of) repetitions of the PIA 151. Limiting a number of times that the same PIA is repeated during the media stream 152 (or during the session associated with the session ID 192) may improve the user experience.

In a particular aspect, the PIA selector 110 may determine (or update) the priority ranking of the PIA 151 based on a time at which the PIA 151 has been previously provided to the client device 102 during the session associated with the media stream 152. For example, the PIA selector 110 may determine that the PIA playback data 174 indicates that the PIA 151 has been provided to the playlist manager 112 (or the client device 102) at approximately a first time in a particular media stream associated with the session ID 192. The particular media stream may include the media stream 152 or another media stream. The PIA selector 110 may determine that the PIA 151 has the non-inclusion priority ranking (e.g., 0) in response to determining, at a second time, that a difference between the first time and the second time fails to satisfy (e.g., is less than) a threshold difference. For example, the PIA selector 110 may provide the PIA 151 at the first time to the playlist manager 112 in a media stream associated with a first station (e.g., a pop music station). After the PIA 151 is played at the client device 102, the user 101 may change the station. For example, the user 101 may select the station associated with the media stream 152. The PIA selector 110 may refrain from adding the PIA 151 in the media stream 152 at the second time in response to determining that the second time is too close to the first time. A technical effect of determining whether to include the PIA 151 in the media stream 152 at the next PIA position 176 based on the first time may be to prevent close (e.g., successive) repetition of the PIA 151 across stations. Increasing a time between repetitions of the same PIA may improve a user experience.

The PIA selector 110 may determine that the PIA 151 has a priority ranking (e.g., the first priority ranking) corresponding to a particular priority (e.g., a highest available priority) in response to determining, at a second time, that a difference between the first time and the second time satisfies (e.g., is greater than or equal to) a threshold difference (e.g., a maximum difference). In a particular aspect, the campaign criteria 124 may indicate that the PIA 151 is to be included in media streams associated with the same session ID (e.g., the session ID 192) at a particular time interval (e.g., every 30 minutes). The threshold difference may correspond to the frequency of insertion (e.g., every 30 minutes) indicated by the campaign criteria 124. A technical effect of setting a priority of the PIA 151 to a highest available priority in response to expiration of a timer may be to enable the user 121 to designate that the PIA 151 is provided to the client device 102 across stations at least once during a time interval.

In a particular aspect, the PIA selector 110 may determine that the PIA 151 satisfies the campaign criteria 124 in response to determining, at a first time, that the campaign criteria 124 indicates a time interval (e.g., a minimum interval) between insertions of the PIA 151 in media streams associated with the session ID 192, that the PIA playback data 174 indicates that the PIA 151 has most recently been included in a media stream associated with the session ID 192 at a second time, and that a difference between the first time and the second time is greater than the time interval indicated by the campaign criteria 124.

In a particular aspect, the PIA selector 110 may determine (or update) the priority ranking of the PIA 151 based on a total number of times that the PIA 151 has been provided to the client device 102 in any media stream during the session corresponding to the session ID 192. The PIA selector 110 may determine that the PIA 151 has the non-inclusion priority ranking (e.g., 0) in response to determining that the total number of times fails to satisfy (e.g., is greater than or equal to) a threshold (e.g., a maximum) count. The PIA selector 110 may refrain from adding the PIA 151 in the media stream 152 at the next PIA position 176 in response to determining that the total number of times fails to satisfy (e.g., is greater than or equal to) a number of times threshold. A technical effect of determining whether to include the PIA 151 in the media stream 152 at the next PIA position 176 based on a number of times that the PIA 151 has been included during the session may be to prevent too many (e.g., greater than the threshold number of) repetitions of the PIA 151 during the session, even across distinct stations. Limiting a number of times that the same PIA is repeated across stations during the session may improve a user experience.

In a particular aspect, the PIA selector 110 may determine (or update) the priority ranking of the PIA 151 based on user feedback associated with the PIA 151. For example, the provider device 104 may receive user feedback (e.g., positive, negative, or neutral) from the client device 102 in response to providing the PIA 151 to the client device 102. The PIA selector 110 may update the PIA playback data 174 to indicate the user feedback associated with the PIA 151. In a particular aspect, the PIA selector 110 may track user feedback associated with PIAs per session, per client device, in aggregate, or a combination thereof. The PIA selector 110 may update the priority ranking of the PIA 151 based on the user feedback. For example, the PIA selector 110 may determine that the PIA 151 has the non-inclusion priority ranking (e.g., 0) in response to determining that the PIA playback data 174 indicates that negative user feedback has been received from the client device 102 regarding the PIA 151 during the session corresponding to the session ID 192.

The PIA selector 110 may determine that a subset of the PIAs 150 satisfy corresponding campaign criteria, as described herein. The PIA selector 110 may select the PIA 151 in response to determining that the PIA 151 has a highest priority among PIAs of the subset.

The PIA selector 110 may determine that the PIA 151 satisfies the campaign criteria 124 in response to determining, at a first time, that the first time is greater than or equal to a campaign start time indicated by the campaign criteria 124, that the first time is less than a campaign end time indicated by the campaign criteria 124, or both. In a particular aspect, the campaign criteria 124 may indicate a frequency of including the PIA 151 in the media stream 152 (or in any media stream) during the session. For example, the campaign criteria 124 may indicate that the PIA 151 is to be included once (e.g., a single frequency), multiple times (e.g., a multiple frequency), or a threshold number of times per media stream or per session. The PIA selector 110 may determine that the PIA 151 fails to satisfy the campaign criteria 124 in response to determining that the campaign criteria 124 indicates the single frequency per media stream (or per session) and that the PIA playback data 174 indicates that the PIA 151 has previously been included in the media stream 152 (or in any media stream associated with the session ID 192). Alternatively, the PIA selector 110 may determine that the PIA 151 satisfies the campaign criteria 124 in response to determining that the campaign criteria 124 indicates the single frequency per media stream (or per session) and that the PIA playback data 174 indicates that the PIA 151 has not previously been included in the media stream 152 (or in any media stream associated with the session ID 192).

In a particular aspect, the PIA selector 110 may determine that the PIA 151 satisfies the campaign criteria 124 in response to determining that the campaign criteria 124 indicates the multiple frequency. In a particular aspect, the PIA selector 110 may determine that the PIA 151 satisfies the campaign criteria 124 in response to determining that the campaign criteria 124 indicates a threshold number of times that the PIA 151 may be included per media stream (or per session) and that the PIA playback data 174 indicates that the PIA 151 has been included fewer than the threshold number of times in the media stream 152 (or in one or more media streams associated with the session ID 192). Alternatively, the PIA selector 110 may determine that the PIA 151 fails to satisfy the campaign criteria 124 in response to determining that the campaign criteria 124 indicates a threshold number of times that the PIA 151 may be included per media stream (or per session) and that the PIA playback data 174 indicates that the PIA 151 has been included at least the threshold number of times in the media stream 152 (or in one or more media streams associated with the session ID 192).

The system 100 may thus enable the playlist manager 112 to select one or more PIAs based on selection criteria, campaign criteria, common characteristics with the station associated with the media stream 152, common characteristics with one or more of the content items 160 of the media stream 152, or a combination thereof. In some examples, the selected PIAs may correspond to the tastes and preferences of the user 101, improving the user experience. In other examples, the PIA selection may override the tastes and preferences of the user 101 to achieve campaign goals.

Referring to FIG. 2, a system is shown and generally designated 200. The system 200 may correspond to the system 100 of FIG. 1. For example, the system 100 may include one or more components of the system 200. The system 200 includes the memory 132 and the campaign manager 106 coupled via a publisher 252 (e.g., a processor) to an ingestor 250 (e.g., a processor). In a particular aspect, the provider device 104 of FIG. 1 may include the publisher 252, the ingestor 250, or both. In another aspect, the publisher 252, the ingestor 250, or both, may be included in one or more other devices (e.g., computer server(s)). For example, the ingestor 250 may correspond to an ingestor device, the publisher 252 may correspond to a publisher device, or both.

The ingestor 250 may be configured to transcode image data, audio data, or both. For example, the ingestor 250 may be configured to generate transcoded image data by transcoding image data from a first image coding format to a second image coding format. Examples of image coding formats may include a raster format, a vector format, or other formats. A raster format may include a Joint Photographic Experts Group (JPEG) format, a JPEF File Interchange Format (JFIF), a tagged image file format (TIFF), a graphics interchange format (GIF), a bitmap (BMP) format, a portable network graphics (PNG) format, or another raster format. The vector format may include a computer graphics metafile (CGM) format, a scalable vector graphics (SVG) format, a vector markup language (VML) format, or another vector format.

The ingestor 250 may be configured to generate transcoded audio data by transcoding audio data from a first audio coding format to a second audio coding format. Examples of audio coding formats may include a waveform audio file format (WAV), an interchange file format (IFF), an audio IFF (AIFF), a resource interchange file format (RIFF), a windows media audio (WMA) format, a Moving Picture Experts Group (MPEG) 1 or 2 Audio Layer III (MP3) format, or other audio coding formats.

The ingestor 250 may be configured to provide a transcode notification to the publisher 252 indicating the transcoded audio data, the transcoded image data, or both. The publisher 252 may be configured to generate the PIA 151 based on the PIA data 181, where the PIA 151 may indicate the transcoded audio data, the transcoded image data, or both.

The memory 132 may be configured to store the campaign criteria 124, the PIA data 181, the selection criterion 126, or a combination thereof. The selection criterion 126 may indicate a global mode 208, a global override mode 210, a two-to-start mode 212, or the targeted mode 214.

The campaign criteria 124 may include a start time 202, an end time 204, a frequency 206, or a combination thereof. The start time 202 may and the end time 204 may each indicate a date, a time, or both. The campaign criteria 124 may indicate that the PIA 151 is to be available to include in one or more media streams at and after the start time 202, and/or that the PIA 151 is available to include in one or more media streams at or before the end time 204.

The frequency 206 may indicate a number of times the PIA 151 may be included in a media stream, a session, or both. For example, the frequency 206 may indicate that the PIA 151 has a single frequency or a multiple frequency per media stream or per session. To illustrate, a first value of the frequency 206 may indicate that the PIA 151 is to be included no more than once in a media stream (e.g., the media stream 152 of FIG. 1), a second value of the frequency 206 may indicate that the PIA 151 is to be included no more than once in a session (e.g., the session corresponding to the session ID 192), a third value of the frequency 206 may indicate that the PIA 151 can be included multiple times in a media stream and can be included in multiple media streams associated with a session, a fourth value of the frequency 206 may indicate that the PIA 151 can be included up to a threshold number of times in one or more media streams associated with a session, etc. In a particular aspect, a value of the frequency 206 may indicate a time interval (e.g., a minimum time interval or a maximum time interval) between insertion of the PIA 151 in media streams associated with a particular session.

The PIA data 181 may include audio data 222, image data 224, or both. The audio data 222 may correspond to an audio identifier of the provider (e.g., a voice recording of “This song brought to you by Internet Radio USA”). The image data 224 may correspond to an image identifier (e.g., an image of a logo) of the provider. The PIA data 181 may include a title 226 of the PIA 151, a description 228 of the PIA 151, or both.

The PIA data 181 may indicate one or more characteristics of the PIA 151. For example, the PIA data 181 may include one or more geographic identifiers 238 indicating geographic location(s) associated with the PIA 151. The audio data 222 may correspond to music associated with a first geographic location, a voice recording in an accent associated with a second geographic location, or both. The geographic identifiers 238 may include a first identifier of the first geographic location, a second identifier of the second geographic location, or both.

In a particular aspect, the PIA data 181 may include one or more artist identifiers 230 indicating artist(s) associated with the PIA 151. For example, the audio data 222 may correspond to music of a first artist, a voice recording of a second artist, or both. The image data 224 may correspond to illustrations of a third artist. The artist identifiers 230 may include a first identifier of the first artist, a second identifier of the second artist, a third identifier of the third artist, or a combination thereof.

In a particular aspect, the PIA data 181 may include one or more genre identifier(s) 232 indicating genre(s) associated with the PIA 151. For example, the audio data 222 may correspond to background music associated with a first genre (e.g., classical music), a voice recording associated with a second genre (e.g., pop music), or both. The genre identifiers 232 may include a first identifier of the first genre, a second identifier of the second genre, or both.

In a particular aspect, the PIA data 181 may include one or more content item identifier(s) 234 indicating content item(s) associated with the PIA 151. For example, the audio data 222 may correspond to one or more content items (e.g., music tracks). The content item identifiers 234 may indicate the one or more content items.

In a particular aspect, the PIA data 181 may include one or more activity identifier(s) 236 indicating one or more activities associated with the PIA 151. For example, the audio data 222 may correspond to music (e.g., upbeat music) associated with one or more first activities (e.g., exercising). The image data 224 may correspond to images (e.g., having bright colors) associated with one or more second activities (e.g., exercising, gardening, being outdoors, or a combination thereof). The activity identifiers 236 may include identifiers of the first activities, the second activities, or a combination thereof.

In a particular aspect, the PIA data 181 may include one or more geographic identifier(s) 238 indicating geographic locations associated with the PIA 151. For example, the audio data 222 may correspond to music that is popular in a particular geographic region. The image data 224 may correspond to images (e.g., images of mountains) that are of (or similar to) a particular geographic location (e.g., Colorado). The geographic identifiers 238 may include identifiers of the particular geographic region, the particular geographic location, or a combination thereof.

In a particular aspect, the PIA data 181 may include one or more demographic identifier(s) 240 indicating demographics associated with the PIA 151. For example, the audio data 222 may correspond to music (e.g., music from television shows for preschoolers) associated with one or more demographics (e.g., preschoolers). The image data 224 may correspond to images (e.g., cartoon images) associated with one or more second demographics (e.g., kids, teens, or both). The activity identifiers 236 may include identifiers of the first demographics, the second demographics, or a combination thereof.

As described with reference to FIG. 1, the provider device 104 of FIG. 1 may receive and store the campaign criteria 124, the PIA data 181, the selection criterion 126, or a combination thereof. In a particular aspect, the campaign manager 106 may, in response to determining that the start time 202 is not indicated in the campaign criteria 124, update the campaign criteria 124 to indicate a receipt time of the campaign criteria 124 as the start time 202.

In a particular aspect, the campaign manager 106 may determine that the content item characteristics 161 indicate one or more characteristics of content items corresponding to the content item identifiers 234 and may update the PIA data 181 based on the one or more characteristics of the content items. For example, the campaign manager 106 may determine that a first content item identifier of the content item identifiers 234 corresponds to a first content item and that the content item characteristics 161 indicate that the first content item is associated with a first geographic location, a first artist, a first genre, a first activity, a first demographic, or a combination thereof. The campaign manager 106 may include a first geographic location identifier of the first geographic location in the geographic identifiers 238, a first artist location identifier of the first artist in the artist identifiers 230, a first genre identifier of the first genre in the genre identifiers 232, a first activity identifier of the first activity in the activity identifiers 236, a first demographic identifier of the first demographic in the demographic identifiers 240, or a combination thereof. A technical effect of compiling the characteristics associated with the PIA 151 based on a content item associated with the PIA is to have a more robust set of characteristics associated with the PIA 151. A burden on the user 121 of FIG. 1 to provide information associated with the PIA 151 may be reduced by dynamically generating at least part of the characteristics associated with the PIA 151.

The campaign manager 106 may provide the PIA data 181 to the publisher 252. The publisher 252 may extract the audio data 222, the image data 224, or both, from the PIA data 181. The publisher 252 may provide the extracted audio data 222, the image data 224, or both, to the ingestor 250. The ingestor 250 may generate transcoded audio data by transcoding the audio data 222 from a first audio coding format to a second audio coding format. The ingestor 250 may generate transcoded image data by transcoding the image data 224 from a first image coding format to a second image coding format. The ingestor 250 may generate a transcode notification 251 indicating that the audio data 222, the image data 224, or both, have been transcoded. The transcode notification 251 may indicate the transcoded audio data, the transcoded image data, or both. For example, the transcoded audio data, the transcoded image data, or both, may be stored at a server and the transcode notification 251 may indicate an image address (e.g., a universal resource locator (URL)) of the transcoded image data, an audio address (e.g., a URL) of the transcoded audio data, or both. The ingestor 250 may provide the transcode notification 251 to the publisher 252.

The publisher 252 may, in response to receiving the transcode notification 251, generate the PIA 151 based on the PIA data 181, the transcode notification 251, or both. For example, the publisher 252 may generate the PIA 151 indicating the transcoded audio data (e.g., the audio address), the transcoded image data (e.g., the image address), or both. In a particular aspect, the publisher 252 may, in response to determining that no image data is indicated by the PIA data 181, that the transcode notification 251 does not indicate transcoded image data, or both, include default transcoded image data in the PIA 151. For example, the default transcoded image data may correspond to a default image identifier of the provider.

The PIA 151 may indicate the title 226, the description 228, or both. The PIA 151 may also indicate one or more characteristics. For example, the publisher 252 may associate the PIA 151 with one or more of the identifiers 230-240. The publisher 252 may also associate the PIA 151 with the selection criterion 126. The publisher 252 may provide the PIA 151 to the campaign manager 106. The campaign manager 106 may update the campaign 172 to indicate the PIA 151. The campaign manager 106 may include the PIA 151 in the PIAs 150.

FIGS. 3-8 illustrate examples of operation of the PIA selector 110 of FIG. 1. FIG. 3 illustrates an example of the PIA selector 110 selecting a PIA associated with the global override mode 210. FIG. 4 illustrates an example of the PIA selector 110 selecting a PIA associated with the two-to-start mode 212. FIGS. 5-7 illustrate an example of the PIA selector 110 selecting a PIA associated with the targeted mode 214. FIG. 8 illustrates an example of the PIA selector 110 selecting a PIA associated with the global mode 208.

The playlist manager 112 may initiate transmission of the media stream 152 prior to selecting any PIAs, a subset of PIAs, or all PIAs to be included in the media stream 152. For example, the playlist manager 112 may initiate transmission of one or more of the content items 160 prior to selecting the PIA 151. As another example, the playlist manager 112 may initiate transmission of one or more of the content items 160, one or more PIAs, or a combination thereof, prior to selecting the PIA 151. In an alternate implementation, the playlist manager 112 may initiate transmission of the media stream 152 subsequent to selecting all PIAs (including the PIA 151) to be included in the media stream 152.

Referring to FIG. 3, a system is shown and generally designated 300. The system 300 may correspond to the system 100 of FIG. 1. For example, the system 100 may include one or more components of the system 300. The system 300 may include the PIA selector 110, the playlist manager 112, the memory 132, or a combination thereof.

During operation, the playlist manager 112 may, in response to receiving the request 142, initialize the previous PIA position 175 to a particular value (e.g., 0). The playlist manager 112 may, in response to receiving the request 142, determine that one or more content items are included in the media stream 152. For example, the playlist manager 112 may determine that a content item 302 is included at a first position (e.g., 1) in the media stream 152. The playlist manager 112 may update (or generate) content item data 326 to indicate that the content item 302 is included at the first position in the media stream 152. A count (e.g., 1) of the one or more content items may be based on a threshold number (e.g., 1) of content items to be included in the media stream 152 prior to an initial PIA (e.g., count≧threshold number). The playlist manager 112 may set the next PIA position 176 (e.g., 2) based on the count (e.g., next PIA position 176=previous PIA position 175+count+1). The playlist manager 112 may provide the media stream data 171 to the PIA selector 110. The media stream data 171 may include the content item data 326, the session ID 192, the activity IDs 144, the station ID 146, or a combination thereof. The selection criteria 170 indicates that a PIA 312 is associated with the global override mode 210, that each of PIAs 316 and 320 are associated with the two-to-start mode 212, that each of PIAs 314 and 322 are associated with the targeted mode 214, and that a PIA 318 is associated with the global mode 208.

The PIA selector 110 may, in response to receiving the media stream data 171, determine the priority rankings 180 based on the selection criteria 170. For example, the PIA selector 110 may determine that the PIA 312 has a first priority ranking (e.g., 1) in response to determining that the PIA 312 is associated with the global override mode 210 and that the PIA playback data 174 indicates that the PIA 312 has not been included in the media stream 152 (or in any media stream associated with the session ID 192). The priority rankings 180 may indicate that the PIA 312 has the first priority ranking. In an alternate aspect, the PIA selector 110 may determine that the PIA 312 has the non-inclusion priority ranking (e.g., 0) in response to determining that the PIA 312 is associated with the global override mode 210 and that the PIA playback data 174 indicates that the PIA 312 has been included in the media stream 152 (or in one or more media streams associated with the session ID 192).

The PIA selector 110 may update the priority ranking of the PIA 312, as described with reference to FIG. 1. For example, the PIA selector 110 may update the priority ranking of the PIA 312 to the non-inclusion priority ranking (e.g., 0) based on a position at which the PIA 312 has been previously included in the media stream 152, a number of times that the PIA 312 has been included in the media stream 152 (or in any media stream associated with the session ID 192), a time at which the PIA 312 has been most recently provided to the client device 102 in a media stream associated with the session ID 192, or a combination thereof, as described with reference to FIG. 1. The PIA selector 110 may determine that a subset of the PIAs 150 satisfy corresponding campaign criteria, as described with reference to FIG. 1. The PIA selector 110 may select the PIA 312 from the subset in response to determining that the priority ranking of the PIA 312 corresponds to a highest priority among priorities indicated by the priority rankings of the PIAs of the subset and that the priority ranking of the PIA 312 is distinct from the non-inclusion priority ranking (e.g., 0).

The PIA selector 110 may provide, at a first time, the PIA 312 to the playlist manager 112. The PIA 312 may correspond to the PIA 151. The PIA selector 110 may update the PIA playback data 174 to indicate that the PIA 312 has been provided to the playlist manager 112 (or the client device 102 of FIG. 1) at approximately the first time, that the PIA 312 is included in the media stream 152 corresponding to the session ID 192, or both.

The playlist manager 112 may, in response to receiving the PIA 312 from the PIA selector 110 may determine that the PIA 312 is to be included in the media stream 152 at the next PIA position 176 (e.g., 2). For example, the playlist manager 112 may determine that the PIA 312 is to be included in the media stream 152 at a location subsequent to the content item 302 at a first position (e.g., 1). The client device 102 may play the PIA 312 subsequent to playing the content item 302 in response to determining that the PIA 312 has a position (e.g., 2) that is subsequent to the first position of the content item 302 in the media stream 152. The playlist manager 112 may update the previous PIA position 175 to indicate the next PIA position 176 (e.g., 2). The previous PIA position 175 may indicate a position of a PIA that is most recently added to the media stream 152. The playlist manager 112 may update the next PIA position 176 (e.g., 5) based on the previous PIA position 175 and the threshold gap (e.g., 1) between PIAs (e.g., next PIA position 176≧previous PIA position 175+threshold gap+1).

The system 300 may thus enable the user 121 to override user tastes and preferences by indicating that the PIA 312 is associated with the global override mode 210. The PIA 312 associated with the global override mode 210 may have a higher priority for inclusion in the media stream 152 independently of the characteristics associated with the PIA 312.

Referring to FIG. 4, a system is shown and generally designated 400. The system 400 may correspond to the system 100 of FIG. 1. For example, the system 100 may include one or more components of the system 400. The system 400 may include the PIA selector 110, the playlist manager 112, the memory 132, or a combination thereof.

During operation, the playlist manager 112 may determine that one or more content items are included in the media stream 152 at positions greater than the previous PIA position 175 (e.g., 2) and less than the next PIA position 176 (e.g., 5). The playlist manager 112 may update (or generate) the content item data 326 to indicate that a content item 404 is included at a first position (e.g., 3) and that a content item 406 is included at a second position (e.g., 4) in the media stream 152. A count (e.g., 2) of the one or more content items may be based on a difference between the previous PIA position 175 and the next PIA position 176.

The PIA selector 110 may determine that the PIA 312 has the non-inclusion priority ranking (e.g., 0) in response to determining that the PIA 312 is associated with the global override mode 210 and that the PIA playback data 174 indicates that the PIA 312 has been included in the media stream 152. The PIA selector 110 may update the priority rankings 180 to indicate that the PIA 312 has the non-inclusion priority ranking (e.g., 0).

The PIA selector 110 may determine that the PIA 320 has the second priority ranking (e.g., 2) in response to determining that the PIA 320 is associated with the two-to-start mode 212, that the PIA 320 is associated with an artist identifier 430, and that the content item characteristics 161 indicate that a threshold number of content items (e.g., 2 content items) at positions preceding the next PIA position 176 are associated with the artist identifier 430. To illustrate, the PIA selector 110 may, in response to determining that the PIA 316 (or the PIA 320) is associated with the two-to-start mode 212, determine whether the content item characteristics 161 indicate that the content item 404 and the content item 406 are associated with at least one artist corresponding to the same artist ID.

The PIA selector 110 may, in response to determining that the content item characteristics 161 indicate that each of the content item 404 and the content item 406 is associated with an artist corresponding to the artist ID 430, determine whether the PIA 316 (or the PIA 320) is associated with the artist ID 430. The PIA selector 110 may, in response to determining that the PIA 320 is associated with the artist ID 430, determine that the PIA 320 has the second priority ranking (e.g., 2). The PIA selector 110 may update the priority rankings 180 to indicate that the PIA 320 has the second priority ranking (e.g., 2). The PIA selector 110 may, in response to determining that the PIA 316 is not associated with the artist ID 430 or that the PIA 316 is associated with an artist ID 432 that is distinct from the artist ID 430, determine that the PIA 316 has the non-inclusion priority ranking (e.g., 0). The PIA selector 110 may update the priority rankings 180 to indicate that the PIA 320 has the non-inclusion priority ranking (e.g., 0).

The PIA selector 110 may determine that a subset of the PIAs 150 satisfy corresponding campaign criteria, as described with reference to FIG. 1. The PIA selector 110 may select the PIA 320 from the subset in response to determining that the priority ranking of the PIA 320 corresponds to a highest priority among priorities indicated by the priority rankings of the PIAs of the subset and that the priority ranking of the PIA 320 is distinct from the particular priority ranking (e.g., 0). The playlist manager 112 may update the previous PIA position 175 to indicate the next PIA position 176 (e.g., 5). The playlist manager 112 may update the next PIA position 176 (e.g., 7) based on the previous PIA position 175 (e.g., 5) and the threshold gap (e.g., 1) between PIAs (e.g., next PIA position 176≧previous PIA position 175+threshold gap+1).

The system 400 may thus enable the user 121 to consider user tastes and preferences by indicating that the PIA 320 is associated with the two-to-start mode 212. The PIA 320 associated with the two-to-start mode 212 may have a priority for inclusion in the media stream 152 based on whether the PIA 320 is associated with an artist that is also associated with a threshold number of preceding content items.

Referring to FIG. 5, a system is shown and generally designated 500. The system 500 may correspond to the system 100 of FIG. 1. For example, the system 100 may include one or more components of the system 500. The system 500 may include the PIA selector 110, the playlist manager 112, the memory 132, or a combination thereof.

During operation, the playlist manager 112 may determine that one or more content items are included in the media stream 152 at positions greater than the previous PIA position 175 (e.g., 5) and less than the next PIA position 176 (e.g., 7). The playlist manager 112 may update (or generate) the content item data 326 to indicate that a content item 508 is included at a first position (e.g., 6) in the media stream 152.

The PIA selector 110 may determine that the PIA 312 has a non-inclusion priority ranking (e.g., 0), as described with reference to FIG. 4. The PIA selector 110 may update the priority rankings 180 to indicate that the PIA 312 has the non-inclusion priority ranking (e.g., 0).

The PIA selector 110 may determine that the PIA 316 (or the PIA 320) has the non-inclusion priority ranking (e.g., 0) in response to determining that the PIA 316 (e.g., the PIA 320) is associated with the two-to-start mode 212, and that the content item characteristics 161 indicate that a threshold number of content items (e.g., 2 content items) at positions preceding the next PIA position 176 are not associated with a common artist identifier. To illustrate, the PIA selector 110 may, in response to determining that the PIA 316 (or the PIA 320) is associated with the two-to-start mode 212, and that the content item characteristics 161 indicates that the content item 406 is associated with the artist identifier 430 and that the content item 508 is associated with the artist identifier 432, determine that the PIA 316 (or the PIA 320) has the non-inclusion priority ranking (e.g., 0). The PIA selector 110 may update the priority rankings 180 to indicate that the PIA 316, the PIA 320, or both, have the non-inclusion priority ranking (e.g., 0).

The PIA selector 110 may, in response to determining that the PIA 314 (or the PIA 322) is associated with the targeted mode 214, determine the priority ranking associated with the PIA 314 (or the PIA 322) based on one or more characteristics of the PIA 314 (or the PIA 322), the station characteristics 148, the content item characteristics 161, the activity IDs 144, or a combination thereof, as further described with reference to FIGS. 6-7. For example, the PIA selector 110 may determine that the PIA 314 has a first particular priority ranking (e.g., 3.1) based on one or more characteristics of the PIA 314, the station characteristics 148, the content item characteristics 161, the activity IDs 144, or a combination thereof, as further described with reference to FIGS. 6-7. The PIA selector 110 may determine that the PIA 322 has a second particular priority ranking (e.g., 3.3) based on one or more characteristics of the PIA 314, the station characteristics 148, the content item characteristics 161, the activity IDs 144, or a combination thereof, as further described with reference to FIGS. 6-7. The PIA selector 110 may update the priority rankings 180 to indicate that the PIA 314 has the first particular priority ranking (e.g., 3.1) and that the PIA 322 has the second particular priority ranking (e.g., 3.3).

In a particular aspect, the PIA selector 110 may track active times corresponding to the PIAs 150, as further described with reference to FIG. 6. The PIA selector 110 may update the priority rankings 180 of the PIAs 150 based on corresponding active times. For example, the PIA selector 110 may determine that multiple PIAs of the PIAs 150 are associated with the targeted mode 214 and have at least one characteristic in common with the station characteristics 148, the content item characteristics 161, the activity IDs 144, or a combination thereof, as described with reference to FIGS. 6-7. The PIA selector 110 may prioritize the multiple PIAs based on corresponding active times. For example, the PIA selector 110 may assign a priority ranking (e.g., 3.1) indicating a highest priority associated with the two-to-start mode 212 to a first PIA having an earliest active time amongst the active times of the multiple PIAs. A technical effect of updating the priority rankings 180 based on active times may be to prioritize PIAs that have corresponded to user tastes and preferences for the longest time.

The PIA selector 110 may determine that a subset of the PIAs 150 satisfy corresponding campaign criteria, as described with reference to FIG. 1. The PIA selector 110 may select the PIA 314 from the subset in response to determining that the priority ranking of the PIA 314 corresponds to a highest priority among priorities indicated by the priority rankings of the PIAs of the subset and that the priority ranking of the PIA 314 is distinct from the non-inclusion priority ranking (e.g., 0). The playlist manager 112 may update the previous PIA position 175 to indicate the next PIA position 176 (e.g., 7). The playlist manager 112 may update the next PIA position 176 (e.g., 9) based on the previous PIA position 175 (e.g., 7) and the threshold gap (e.g., 1) between PIAs (e.g., next PIA position 176≧previous PIA position 175+threshold gap+1).

The system 500 may thus enable the user 121 to consider user tastes and preferences by indicating that the PIA 314 is associated with the targeted mode 214. The PIA 314 associated with the targeted mode 214 may have a priority for inclusion in the media stream 152 based on one or more characteristics of the PIA 314, the content item characteristics 161, the station characteristics 148, the activity Ds 144, or a combination thereof.

Referring to FIG. 6, a system is shown and generally designated 600. The system 600 may correspond to the system 100 of FIG. 1. For example, the system 100 may include one or more components of the system 600. The system 600 includes the PIA selector 110. The PIA selector 110 may be coupled to the memory 132.

The PIA selector 110 may, in response to determining that the PIA 151 is associated with the targeted mode 214, determine a priority ranking 680 of the PIA 151 based on one or more characteristics of the PIA 314, the station characteristics 148, the content item characteristics 161, the activity IDs 144, or a combination thereof. In a particular aspect, the PIA 151 may correspond to at least one of the PIA 314 or the PIA 322 of FIG. 3.

The PIA selector 110 may determine that the priority ranking 680 corresponds to a first particular priority ranking that is distinct from the non-inclusion priority ranking (e.g., 0) in response to determining that the PIA 151 has at least one characteristic in common with the station characteristics 148, the content item characteristics 161, the activity IDs 144, or a combination thereof. Alternatively, the PIA selector 110 may determine that the priority ranking 680 corresponds to the non-inclusion priority ranking (e.g., 0) in response to determining that the PIA 151 has no characteristics in common with the station characteristics 148, the content item characteristics 161, the activity IDs 144, or a combination thereof.

The PIA selector 110 may determine the priority ranking 680 based on whether the PIA 151 satisfies a plurality of conditions that are based on the station characteristics 148, the content item characteristics 161, the activity IDs 144, or a combination thereof. The PIA selector 110 may determine that a first content item condition of the plurality of conditions is satisfied in response to determining that the artist IDs 230 associated with the PIA 151 include at least one of one or more artist IDs 630 associated with a first content item of the media stream 152. In a particular aspect, the first content item may be included at a first position in the media stream 152. The PIA selector 110 may determine the first position based on the next PIA position 176 (e.g., first position=next PIA position 176−1). The PIA selector 110 may determine that a second content item condition of the plurality of conditions is satisfied in response to determining that the genre IDs 232 associated with the PIA 151 include at least one of one or more genre IDs 632 associated with a first content item of the media stream 152. The PIA selector 110 may determine that a third content item condition of the plurality of conditions is satisfied in response to determining that the content item IDs 234 associated with the PIA 151 include a content item ID 634 associated with a first content item of the media stream 152. The PIA selector 110 may determine that a fourth content item condition of the plurality of conditions is satisfied in response to determining that the activity IDs 236 associated with the PIA 151 include at least one of one or more activity IDs 636 associated with a first content item of the media stream 152. The PIA selector 110 may determine that a fifth content item condition of the plurality of conditions is satisfied in response to determining that the geographic IDs 238 associated with the PIA 151 include at least one of one or more geographic IDs 638 associated with a first content item of the media stream 152. The PIA selector 110 may determine that a sixth content item condition of the plurality of conditions is satisfied in response to determining that the demographic IDs 240 associated with the PIA 151 include at least one of one or more demographic IDs 640 associated with a first content item of the media stream 152.

The PIA selector 110 may determine that a first station condition of the plurality of conditions is satisfied in response to determining that the artist IDs 230 associated with the PIA 151 include an artist ID 620 of the station characteristics 148. The PIA selector 110 may determine that a second station condition of the plurality of conditions is satisfied in response to determining that the genre IDs 232 associated with the PIA 151 include a genre ID 622 associated with the station characteristics 148. The PIA selector 110 may determine that a third station condition of the plurality of conditions is satisfied in response to determining that the activity IDs 236 associated with the PIA 151 include an activity ID 626 associated with the station characteristics 148. The PIA selector 110 may determine that a fourth station condition of the plurality of conditions is satisfied in response to determining that the geographic IDs 238 associated with the PIA 151 include the geographic ID 628 associated with the station characteristics 148. The PIA selector 110 may determine that a fifth station condition of the plurality of conditions is satisfied in response to determining that the demographic IDs 240 associated with the PIA 151 include a demographic ID 660 associated with the station characteristics 148. The PIA selector 110 may determine that a device activity condition of the plurality of conditions is satisfied in response to determining that the activity IDs 236 associated with the PIA 151 include at least one of the activity IDs 144.

In a particular aspect, the PIA selector 110 may, in response to determining that the PIA 151 has at least one of the plurality of conditions is satisfied, determine that the priority ranking 680 corresponds to a first particular priority ranking (e.g., 3) independently of which conditions are satisfied or a count of conditions satisfied. In an alternate aspect, the PIA selector 110 may determine the priority ranking 680 in a range of values (e.g., greater than 3 and less than 4) based on which conditions are satisfied, a count of conditions satisfied, or both. For example, the priority ranking 680 may correspond to a weighted sum based on the satisfied conditions (e.g., priority ranking 680=Σₙ₌₁^{n=count}wₙcₙ, where count=count of the plurality of conditions, wₙ=weight associated with condition n, cₙ=1 when condition n is satisfied, cₙ=0 when condition n is not satisfied). As another example, the priority ranking 680 may correspond to a highest weight associated with a satisfied condition (e.g., priority ranking 680=max_{1≦n≦count}wₙcₙ, where count=count of the plurality of conditions, wₙ=weight associated with condition n, cₙ=1 when a condition n is satisfied, cₙ=0 when the condition n is not satisfied). In this example, the PIA selector 110 may determine whether the plurality of conditions is satisfied in order of weights from a highest weight to a lowest weight. The PIA selector 110 may determine that the priority ranking 680 corresponds to a weight of a first satisfied condition without processing the subsequent conditions. The PIA selector 110 may determine that the priority ranking 680 corresponds to the non-inclusion priority ranking (e.g., 0) in response to determining that none of the plurality of conditions are satisfied.

The PIA selector 110 may track an active time associated with the PIAs 150. For example, the PIA selector 110 may, in response to determining that the PIA playback data 174 indicates that the PIA 151 is inactive and that the PIA 151 satisfied at least one of the plurality of conditions, update the PIA playback data 174 at a first time to indicate that the PIA 151 is active since approximately the first time. Alternatively, the PIA selector 110 may, in response to determining that the PIA playback data 174 indicates that the PIA 151 is active and that the PIA 151 satisfied none of the plurality of conditions, update the PIA playback data 174 to indicate that the PIA 151 is inactive.

Referring to FIG. 7, a particular example of a method of operation is shown and generally designated 700. The method 700 may be performed by the PIA selector 110, the provider device 104, the system 100 of FIG. 1, or a combination thereof. The method 700 is an example of determining the priority ranking 680 of FIG. 6.

The method 700 includes determining whether an artist ID associated with a station corresponds to an artist ID associated with a PIA, at 702. For example, the PIA selector 110 of FIG. 1 may determine whether the artist ID 620 of FIG. 6 corresponds to at least one of the artist IDs 230 of FIG. 2, as described with reference to FIG. 6.

The method 700 also includes, in response to determining that the artist ID associated with the station corresponds to the artist ID associated with the PIA, at 702, determining that the PIA has a first priority ranking, at 704. For example, the PIA selector 110 of FIG. 1 may, in response to determining that the artist ID 620 of FIG. 6 corresponds to at least one of the artist IDs 230 of FIG. 2, determine that the priority ranking 680 of the PIA 151 corresponds to a first value (e.g., 3.1), as described with reference to FIG. 6.

The method 700 further includes, in response to determining that the artist ID associated with the station does not correspond to the artist ID associated with the PIA, at 702, determining whether a genre ID associated with a content item corresponds to a genre ID associated with the PIA, at 706. For example, the PIA selector 110 of FIG. 1 may, in response to determining that the artist ID 620 of FIG. 6 does not correspond to at least one of the artist IDs 230 of FIG. 2, determine whether at least one of the genre IDs 632 associated with a first content item of the media stream 152 corresponds to at least one of the genre IDs 232, as described with reference to FIG. 6.

The method 700 also includes, in response to determining that the genre ID associated with the content item corresponds to the genre ID associated with the PIA, at 706, determining that the PIA has a second priority ranking, at 708. For example, the PIA selector 110 of FIG. 1 may, in response to determining that at least one of the genre IDs 632 associated with the first content item corresponds to at least one of the genre IDs 232, determine that the priority ranking 680 of the PIA 151 corresponds to a second value (e.g., 3.2), as described with reference to FIG. 6.

The method 700 further includes, in response to determining that the genre ID associated with the content item does not correspond to the genre ID associated with the PIA, at 706, determining whether an artist ID associated with the content item corresponds to an artist ID associated with the PIA, at 710. For example, the PIA selector 110 of FIG. 1 may, in response to determining that none of the genre IDs 632 associated with the first content item correspond to any of the genre IDs 232, determining whether at least one of the artist IDs 630 associated with the first content item corresponds to at least one of the artist IDs 230, as described with reference to FIG. 6.

The method 700 also includes, in response to determining that the artist ID associated with the content item corresponds to the artist ID associated with the PIA, at 710, determining that the PIA has a third priority ranking, at 712. For example, the PIA selector 110 of FIG. 1 may, in response to determining that at least one of the artist IDs 630 associated with the first content item corresponds to at least one of the artist IDs 230, determining that the priority ranking 680 of the PIA 151 corresponds to a third value (e.g., 3.3), as described with reference to FIG. 6.

The method 700 further includes, in response to determining that the artist ID associated with the content item does not correspond to the artist ID associated with the PIA, at 710, determining whether a content item ID of the content item corresponds to a content item ID associated with the PIA, at 714. For example, the PIA selector 110 of FIG. 1 may, in response to determining that none of the artist IDs 630 associated with the first content item correspond to any of the artist IDs 230, determining whether the content item ID 634 associated with the first content item corresponds to at least one of the content item IDs 234, as described with reference to FIG. 6.

The method 700 also includes, in response to determining that the content item ID of the content item corresponds to the content item ID associated with the PIA, at 714, determining that the PIA has a fourth priority ranking, at 716. For example, the PIA selector 110 of FIG. 1 may, in response to determining that the content item ID 634 associated with the first content item corresponds to at least one of the content item IDs 234, determining that the priority ranking 680 of the PIA 151 corresponds to a fourth value (e.g., 3.4), as described with reference to FIG. 6.

The method 700 further includes, in response to determining that the content item ID of the content item does not correspond to the content item ID associated with the PIA, at 714, determining whether an activity ID associated with the station corresponds to an activity ID associated with the PIA, at 718. For example, the PIA selector 110 of FIG. 1 may, in response to determining that the content item ID 634 associated with the first content item does not correspond to at least one of the content item IDs 234, determining whether the activity ID 626 corresponds to at least one of the activity IDs 236, as further described with reference to FIG. 6.

The method 700 also includes in response to determining that the activity ID associated with the station corresponds to the activity ID associated with the PIA, at 718, determining that the PIA has a fifth priority ranking, at 720. For example, the PIA selector 110 of FIG. 1 may, in response to determining that the activity ID 626 corresponds to at least one of the activity IDs 236, determining that the priority ranking 680 of the PIA 151 corresponds to a fifth value (e.g., 3.5), as further described with reference to FIG. 6.

The method 700 further includes in response to determining that the activity ID associated with the station does not correspond to the activity ID associated with the PIA, at 718, determining that the PIA has a particular priority ranking, at 722. For example, the PIA selector 110 of FIG. 1 may, in response to determining that the activity ID 626 does not correspond to at least one of the activity IDs 236, determining that the priority ranking 680 of the PIA 151 corresponds to the non-inclusion priority ranking (e.g., 0), as further described with reference to FIG. 6

Referring to FIG. 8, a system is shown and generally designated 800. The system 800 may correspond to the system 100 of FIG. 1. For example, the system 100 may include one or more components of the system 800. The system 800 may include the PIA selector 110, the playlist manager 112, the memory 132, or a combination thereof.

During operation, the playlist manager 112 may determine that one or more content items are included in the media stream 152 at positions greater than the previous PIA position 175 (e.g., 7) and less than the next PIA position 176 (e.g., 9). The playlist manager 112 may update (or generate) the content item data 326 to indicate that a content item 610 is included at a first position (e.g., 8) in the media stream 152.

The PIA selector 110 may determine that the PIA 312 has the non-inclusion priority ranking (e.g., 0), as described with reference to FIG. 4. The PIA selector 110 may determine that the PIA 316 (or the PIA 320) has the non-inclusion priority ranking (e.g., 0) in response to determining that the PIA 316 (e.g., the PIA 320) is associated with the two-to-start mode 212, and that the content item characteristics 161 indicate that a threshold number of content items (e.g., 2 content items) at positions preceding the next PIA position 176 are not associated with a common artist identifier, as described with reference to FIG. 5.

The PIA selector 110 may, in response to determining that the PIA 314 (or the PIA 322) is associated with the targeted mode 214, determine the priority ranking associated with the PIA 314 (or the PIA 322), as further described with reference to FIGS. 6-7. For example, the PIA selector 110 may determine that the PIA 314 has a first particular priority ranking (e.g., 3.1) based on one or more characteristics of the PIA 314, the station characteristics 148, the content item characteristics 161, the activity IDs 144, or a combination thereof, as further described with reference to FIGS. 6-7. The PIA selector 110 may update the priority rankings 180 to indicate that the PIA 314 has the first particular priority ranking (e.g., 3.1). The PIA selector 110 may determine that the PIA 322 has a the non-inclusion priority ranking (e.g., 0) based on one or more characteristics of the PIA 322, the station characteristics 148, the content item characteristics 161, the activity IDs 144, or a combination thereof, as further described with reference to FIGS. 6-7. The PIA selector 110 may update the priority rankings 180 to indicate that the PIA 322 has the non-inclusion priority ranking (e.g., 0).

In a particular aspect, the PIA selector 110 may update the priority ranking of the PIA 314 to the non-inclusion priority ranking (e.g., 0) in response to determining that the PIA 314 has been included in the media stream 152 at a first position (e.g., 7) and that a difference between the first position and the next PIA position 176 fails to satisfy (e.g., is less than) a threshold difference. The PIA selector 110 may update the priority rankings 180 to indicate that the PIA 314 has the non-inclusion priority ranking (e.g., 0).

The PIA selector 110 may determine that the PIA 318 has the fourth priority ranking (e.g., 4) in response to determining that the PIA 318 is associated with the global mode 208. The PIA selector 110 may determine that a subset of the PIAs 150 satisfy corresponding campaign criteria, as described with reference to FIG. 1. The PIA selector 110 may select the PIA 318 from the subset in response to determining that the priority ranking (e.g., 4) of the PIA 318 corresponds to a highest priority among priorities indicated by the priority rankings of the PIAs of the subset and that the priority ranking of the PIA 318 is distinct from the non-inclusion priority ranking (e.g., 0).

The playlist manager 112 may update the previous PIA position 175 to indicate the next PIA position 176 (e.g., 9). The system 800 may thus enable the user 121 to designate the PIA 318 to be displayed when no available PIAs correspond to user tastes and preferences by indicating that the PIA 318 is associated with the global mode 208.

Referring to FIG. 9, a particular example of a method of operation is shown and generally designated 900. The method 900 may be performed by the PIA selector 110, the playlist manager 112, the provider device 104, the system 100 of FIG. 1, or a combination thereof.

The method 900 includes generating at a media stream at a server, at 902. For example, the playlist manager 112 at the provider device 104 of FIG. 1 may generate the media stream 152, as described with reference to FIG. 1. The media stream 152 may include the content items 160.

The method 900 also includes assigning, at the server, a priority ranking to each of a plurality of provider identifier announcements based on one or more selection criteria, at 904. For example, the PIA selector 110 at the provider device 104 of FIG. 1 may assign priority rankings 180 to the PIAs 150 based on the selection criteria 170, as further described with reference to FIG. 1.

The method 900 further includes inserting, at the server, a provider identifier announcement of a plurality of provider identifier announcements in the media stream based on the priority ranking and one or more campaign criteria of a campaign associated with the provider identifier announcement, at 906. For example, the playlist manager 112 at the provider device 104 of FIG. 1 may insert the PIA 151 in the media stream 152 based on the priority rankings 180 and the campaign criteria 124, as described with reference to FIG. 1. The campaign criteria 124 may include at least one of a campaign start time (e.g., the start time 202 of FIG. 2), a campaign end time (e.g., the end time 204 of FIG. 2), or a frequency (e.g., the frequency 206 of FIG. 2) of inserting the provider identifier announcement in the media stream 152. It should be understood that one or more operations described with reference to the method 900 may be performed at a server, at a device integrated in a server, at a component of a server, at another device, or a combination thereof.

FIG. 10 is a block diagram of a computing environment 1000 including a computing device 1010 that is operable to support embodiments of computer-implemented methods, computer program products, and system components according to the present disclosure.

The computing device 1010 includes at least one processor 1020 and the memory 132 (e.g., a system memory). For example, the computing device 1010 may be a desktop computer, a laptop computer, a tablet computer, a server, a cloud computing device, or any other fixed or mobile computing device. The at least one processor 1020 may include the PIA selector 110, the playlist manager 112, the campaign manager 106, the ingestor 250, the publisher 252, or a combination thereof. Depending on the configuration and type of computing device, the memory 132 may include volatile (such as random access memory or “RAM”), non-volatile (such as read-only memory or “ROM,” flash memory, and similar memory devices that maintain stored data even when power is not provided), a combination thereof, or some other memory. The memory 132 may store an operating system 1032, program data 1038, or both. The program data 1038 may include the previous PIA position 175, the next PIA position 176, the station characteristics 148, the content item characteristics 161, the media stream data 171, the PIAs 150, the priority rankings 180, the selection criteria 170, the PIA playback data 174, the activity IDs 144, the station ID 146, the session ID 192, the PIA data 181, the campaign criteria 124, the selection criterion 126 of FIG. 1, or a combination thereof. In an illustrative embodiment, the computing device 1010 may correspond to the provider device 104 of FIG. 1.

The computing device 1010 may also have additional features or functionality. For example, the computing device 1010 may also include removable and/or non-removable additional data storage devices, such as magnetic disks, optical disks, tape, and memory cards. Such additional storage is illustrated in FIG. 10 by a data store 1040. Computer-readable or processor-readable storage media may include volatile and/or non-volatile storage and removable and/or non-removable media implemented in any technology for storage of information such as computer-readable instructions, data structures, program components or other data. The memory 132 and the data store 1040 are examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, and other non-transitory media that can be used to store information and that can be accessed by the computing device 1010. Any such computer storage media may be part of the computing device 1010.

The computing device 1010 may also have one or more input devices, such as an external device 1062 connected via one or more input interfaces 1060. One or more output devices, such as an illustrative display device 1092, speakers, a printer, etc. may also be connected to the computing device 1010 via one or more output interfaces 1070. The input interfaces 1060 and the output interfaces 1070 may each include one or more wired or wireless interfaces, such as a universal serial bus (USB) interface, a video graphics array (VGA) interface, a serial interface, a digital visual interface (DVI), a high-definition multimedia interface (HDMI), or some other interface. In certain embodiments, such as when the computing device 1010 is a server, the input interfaces 1060 and the output interfaces 1070 may not be included. The computing device 1010 has one or more communication interfaces 1080 that enable the computing device 1010 to communicate (e.g., via a network) with other computing devices, such as the client device 102, the device 122, or both.

Particular embodiments of disclosed techniques may be implemented in conjunction with a client-server architecture. To illustrate, the computing device 1010 may be an application server or other server that provides media streaming functionality. Clients (e.g., the device 122) may transmit the PIA data 181, the campaign criteria 124, the selection criterion 126 of FIG. 1, or a combination thereof, to the server for generation of the PIA 151. The server may select the PIA 151 for inclusion in the media stream 152 based at least in part on the PIA data 181, the campaign criteria 124, the selection criterion 126 of FIG. 1, or a combination thereof. The server may provide the media stream 152 (including the PIA 151) to a client (e.g., the client device 102), as described with reference to FIG. 1.

It will be appreciated that not all of the components or devices illustrated in FIG. 10 or otherwise described in the previous paragraphs are necessary to support embodiments as herein described. It will also be appreciated that the computing device 1010 may have additional or different components or devices than illustrated in FIG. 10 or otherwise described in the previous paragraphs.

Although the exemplary embodiments described herein are intended to enable a person skilled in the art to practice such embodiments, it should be understood that other embodiments may be realized and that logical and physical changes may be made without departing from the scope of the present disclosure. Thus, the detailed description herein is presented for purposes of illustration only.

In one embodiment, portions of the present disclosure may be implemented using a system that includes a software module, logic engines, computer hardware, databases, and/or computer networks. Moreover, while the description may make reference to specific technologies, system architectures, and data management techniques, it will be appreciated that other devices and/or methods that use different technologies, architectures, or techniques may be implemented without departing from the scope of the disclosure. This disclosure is intended to cover any and all subsequent adaptations or variations of various embodiments.

As will be appreciated by one skilled in the art, some embodiments may be embodied as a system, method, or computer program product. Accordingly, some embodiment may take the form of an entirely hardware implementation, an entirely software implementation (including firmware, resident software, micro-code, etc.) or a combination of software and hardware aspects that may all generally be referred to herein as a “circuit,” “module,” or system.” Furthermore, some embodiments may take the form of a computer program product embodied in a tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, radio frequency (RF), etc. Computer program code for carrying out operations of the disclosure may be written in any combination of one or more programming languages, including an object oriented programming language, such as Java, Smalltalk, C++, or the like, and conventional procedural programming languages, such as the “C” programming language, or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Various embodiments are described with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create mans for implementing the functions/acts specified in the flowchart and/or block diagram block or blocks. The computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in FIGS. 1-10 illustrate the architecture, functionality, and operation of possible implementations of systems, methods, and computer program products according to various disclosed embodiments. In this regard, each block in the flowchart or block diagrams may represent a module, a segment, or a portion of code, which includes one or more executable instructions for implementing the specified logical function(s). It should also be noted that, in some alternative implementations, the functions noted in the block may occur out of order noted in the FIGS. 1-10. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope and spirit of this technology. Some implementations were chosen and described in order to explain the principles and practical application, and to enable others of ordinary skill in the art to understand various implementations with various modifications as are suited to particular uses contemplated.

The Abstract is not intended to be used in interpreting or limiting the scope or meaning of the claims. In addition, the disclosure is not to be interpreted as indicating that the claimed embodiments require more features than are expressly recited in each claim. Thus, the present disclosure is not intended to be limited to the embodiments shown herein but is to be accorded the widest scope possible consistent with the principles and novel features as defined by the following claims.

1. A system comprising:
a playlist manager configured to:
generate a media stream at a device associated with a provider, the media stream including multiple content items;
assign a priority ranking to each of a plurality of provider identifier announcements based on one or more selection criteria, wherein each of the plurality of provider identifier announcements identifies the provider; and
insert a provider identifier announcement of the plurality of provider identifier announcements in the media stream based on the priority ranking and one or more campaign criteria of a campaign associated with the provider identifier announcement, wherein the one or more campaign criteria include at least one of a campaign start time, a campaign end time, or a frequency of inserting the provider identifier announcement in the media stream.

2. The system of claim 1, wherein the provider identifier announcement corresponds to audio data, image data, or both.

3. The system of claim 1, wherein a selection criterion of the one or more selection criteria is associated with the provider identifier announcement, and wherein the selection criterion corresponds to at least one of a global override mode, a targeted mode, a two-to-start mode, or a global mode.

4. The system of claim 1, wherein the playlist manager is configured to assign a first priority ranking to the provider identifier announcement in response to determining that a selection criterion associated with the provider identifier announcement corresponds to a global override mode and that the provider identifier announcement has not been included in the media stream.

5. The system of claim 1, wherein the playlist manager is configured to assign a second priority ranking to the provider identifier announcement in response to determining that a selection criterion associated with the provider identifier announcement corresponds to a two-to-start mode, that the provider identifier announcement is associated with an artist, and that a count of consecutive content items of the multiple content items of the media stream associated with the artist is greater than a threshold.

6. The system of claim 1, wherein the playlist manager is configured to assign a third priority ranking to the provider identifier announcement in response to determining that a selection criterion associated with the provider identifier announcement corresponds to a targeted mode and that the provider identifier announcement is associated with at least one of a station characteristic or a content item characteristic.

7. The system of claim 6, wherein the playlist manager is configured to determine that the media stream is associated with a station based on station data, and wherein the station characteristic includes an artist associated with the station, an activity associated with the station, a genre associated with the station, a demographic associated with the station, a geographic location associated with the station, or a combination thereof.

8. The system of claim 6, wherein the content item characteristic includes a genre associated with one or more of the multiple content items of the media stream, an artist associated with the one or more of the multiple content items of the media stream, a demographic associated with the one or more of the multiple content items of the media stream, a geographic location associated with the one or more of the multiple content items of the media stream, an activity associated with the one or more of the multiple content items of the media stream, or a combination thereof.

9. The system of claim 1, wherein the playlist manager is configured to assign a fourth priority ranking to the provider identifier announcement in response to determining that a selection criterion associated with the provider identifier announcement corresponds to a global mode and that the provider identifier announcement has not been included in the media stream.

10. The system of claim 1, wherein the playlist manager is configured to assign a fifth priority ranking to the provider identifier announcement in response to determining that a difference between a first position at which the provider identifier announcement has been included in the media stream and a next provider identifier announcement position in the media stream is less than a threshold.

11. The system of claim 1, further comprising:
an ingestor device configured to:
generate transcoded audio data by transcoding audio data; and
generate a transcode notification indicating the transcoded audio data;
a publisher device configured to:
provide the audio data to the ingestor device; and
generate the provider identifier announcement in response to receiving the transcode notification from the ingestor device, the provider identifier announcement indicating the transcoded audio data; and
a campaign manager configured to:
send provider identifier announcement data to the publisher device, the provider identifier announcement data including the audio data; and
in response to receiving the provider identifier announcement from the publisher device, generate the campaign based on the provider identifier announcement, the campaign start time, the campaign end time, the frequency of inserting the provider identifier announcement in the media stream, or a combination thereof.

12. A method comprising:
generating a media stream at a device, the media stream including multiple content items;
assigning, at the device, a priority ranking to each of a plurality of provider identifier announcements based on one or more selection criteria; and
inserting, at the device, a provider identifier announcement of the plurality of provider identifier announcements in the media stream based on the priority ranking and one or more campaign criteria of a campaign associated with the provider identifier announcement,
wherein the one or more campaign criteria include at least one of a campaign start time, a campaign end time, or a frequency of inserting the provider identifier announcement in the media stream.

13. The method of claim 12, further comprising sending the media stream from the device to a client device.

14. The method of claim 12, wherein the one or more selection criteria include a selection criterion associated with the provider identifier announcement, wherein the selection criterion corresponds to at least one of a global override mode, a targeted mode, a two-to-start mode, or a global mode.

15. The method of claim 12, further comprising assigning a first priority ranking to the provider identifier announcement in response to determining that a selection criterion associated with the provider identifier announcement corresponds to a global override mode and that the provider identifier announcement has not been included in the media stream.

16. The method of claim 12, further comprising assigning a particular priority ranking to the provider identifier announcement in response to determining that a selection criterion associated with the provider identifier announcement corresponds to a targeted mode and that the provider identifier announcement is associated with at least one of a station characteristic or a content item characteristic.

17. The method of claim 16, further comprising determining that the media stream is associated with a station based on station data, wherein the station characteristic includes a station artist associated with the station, a station activity associated with the station, a station genre associated with the station, a station demographic associated with the station, a station geographic location associated with the station, or a combination thereof, and wherein the content item characteristic includes a content item genre associated with one or more of the multiple content items of the media stream, a content item artist associated with the one or more of the multiple content items of the media stream, a content item demographic associated with the one or more of the multiple content items of the media stream, a content item geographic location associated with the one or more of the multiple content items of the media stream, a content item activity associated with the one or more of the multiple content items of the media stream, or a combination thereof.

18. A computer-readable storage device storing instructions that, when executed by a processor, cause the processor to perform operations comprising:
generating a media stream at a device associated with a provider, the media stream including multiple content items;
assigning a priority ranking to each of a plurality of provider identifier announcements based on one or more selection criteria, wherein each of the plurality of provider identifier announcements identifies the provider; and
inserting a provider identifier announcement of the plurality of provider identifier announcements in the media stream based on the priority ranking and one or more campaign criteria of a campaign associated with the provider identifier announcement, wherein the one or more campaign criteria include at least one of a campaign start time, a campaign end time, or a frequency of inserting the provider identifier announcement in the media stream.

19. The computer-readable storage device of claim 18, wherein the operations further comprise:
receiving a request for the media stream from a client device; and
assigning a particular priority ranking to the provider identifier announcement in response to determining that a selection criterion associated with the provider identifier announcement corresponds to a targeted mode and that the provider identifier announcement is associated with a geographic location of the client device.

20. The computer-readable storage device of claim 18, wherein the operations further comprise:
receiving activity data in conjunction with a request for the media stream from a client device;
determining an activity associated with the client device based on the activity data; and
assigning a particular priority ranking to the provider identifier announcement in response to determining that a selection criterion associated with the provider identifier announcement corresponds to a targeted mode and that the provider identifier announcement is associated with the activity.
